(19) United States
(12) Patent Application Publication
(10) Pub. No.: US 2025/0330883 A1
(43) Pub. Date: Oct. 23, 2025

(54) TECHNIQUES FOR UPLINK TIME ALIGNMENT TIMER MANAGEMENT FOR MULTIPLE TRANSMISSION-RECEPTION POINTS

(71) Applicant: QUALCOMM Incorporated, San Diego, CA (US)

(72) Inventors: Shaozhen GUO, Beijing (CN); Mostafa KHOSHNEVISAN, San Diego, CA (US); Fang YUAN, Beijing (CN)

(21) Appl. No.: 19/112,514

(22) PCT Filed: Nov. 4, 2022
(86) PCT No.: PCT/CN2022/129750

§ 371 Date: Mar. 17, 2025

(51) Int. Cl. H04W 36/00; H04L 1/1812; H04L 5/00

(52) U.S. Cl. CPC H04W 36/0072; H04L 1/1812; H04L 5/0044

(57) ABSTRACT

Methods, systems, and devices for wireless communications are described. A user equipment (UE) may receive a control message indicating a first timing advance group (TAG) and a first time alignment timer (TAT) associated with the first TAG and a first transmission-reception point (TRP) for a serving cell. The control message may indicate a second TAG and a second TAT associated with the second TAG associated with a second TRP for the serving cell. The UE may release one or more network parameters at a TRP-level or one or more network parameters at a cell-level, or both, based on the first time alignment timer expiring. The UE may communicate with the first TRP or the second TRP, or both, based on the first TAT expiring.

### CROSS REFERENCE

This application is a 371 National Stage of PCT Application No. PCT/CN2022/129750, filed on Nov. 4, 2022, entitled “TECHNIQUES FOR UPLINK TIME ALIGNMENT TIMER MANAGEMENT FOR MULTIPLE TRANSMISSION-RECEPTION POINTS”, and assigned to the assignee hereof. The disclosure of the prior Application is considered part of and is incorporated by reference into this Patent Application.

### FIELD OF TECHNOLOGY

The following relates to wireless communications, including techniques for uplink time alignment timer (TAT) management for multiple transmission-reception points.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for uplink time alignment timer (TAT) management for multiple transmission-reception points (TRPs). For example, the described techniques provide for a user equipment (UE) configured with multiple timing advance groups (TAGs) for a cell using multiple TATs to release network parameters at a cell-level or a TRP-level, or both. For example, the UE may be configured with a first TAG and a second TAG. The first TAG may be configured with a first TAT and associated with a first TRP, and the second TAG may be configured with a second TAT and associated with a second TRP. When one or more of the TATs expire, the UE may be configured to release network parameters at a cell-level or a TRP-level, or both. For example, the UE may release resources, such as uplink control channel, sounding reference signal (SRS) resources, downlink assignments, uplink shared channel resources for channel state information (CSI) reporting, or any combination thereof, at a TRP-level. Additionally, or alternatively, the UE may flush, or clear, hybrid automatic repeat request (HARQ) buffers (e.g., for uplink or downlink, or both), at a cell-level or at a TRP-level. In some examples, how the UE releases network parameters (e.g., at a cell-level or TRP-level, or for which TAGs or serving cells) may be based on a TAG associated with an expired TAT, such as whether the TAG is a primary TAG or a secondary TAG, a capability of the UE, or an acknowledgment feedback mode configured for the UE.

A method for wireless communications at a UE is described. The method may include receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, releasing a first one or more network parameters at a TRP-level or a second one or more network parameters at a cell-level, or both, based on the first TAT expiring, and communicating with the first TRP or the second TRP, or both, based on the first TAT expiring.

An apparatus for wireless communications at a UE is described. The apparatus may include memory, a transceiver, and at least one processor coupled with the memory and the transceiver. The at least one processor of the UE may be configured to receive a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, release a first one or more network parameters at a TRP-level or a second one or more network parameters at a cell-level, or both, based on the first TAT expiring, and communicate with the first TRP or the second TRP, or both, based on the first TAT expiring.

Another apparatus for wireless communications at a UE is described. The apparatus may include means for receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, means for releasing a first one or more network parameters at a TRP-level or a second one or more network parameters at a cell-level, or both, based on the first TAT expiring, and means for communicating with the first TRP or the second TRP, or both, based on the first TAT expiring.

A non-transitory computer-readable medium storing code for wireless communications at a UE is described. The code may include instructions executable by a processor to receive a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, release a first one or more network parameters at a TRP-level or a second one or more network parameters at a cell-level, or both, based on the first TAT expiring, and communicate with the first TRP or the second TRP, or both, based on the first TAT expiring.

In some examples of the method, apparatuses, and non-transitory computer-readable medium described herein, the releasing may include operations, features, means, or instructions for releasing the first one or more network parameters at the TRP-level for the first TRP based on the first TAG being a first primary TAG and the second TAG being a second primary TAG.

In some examples of the method, apparatuses, and non-transitory computer-readable medium described herein, the first one or more network parameters may be released for all serving cells in a cell group associated with the first TRP.

In some examples of the method, apparatuses, and non-transitory computer-readable medium described herein, the communicating may include operations, features, means, or instructions for communicating with the second TRP via the second one or more network parameters associated with the second TRP.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAG being a first primary TAG and the second TAG being a second primary TAG.

In some examples of the method, apparatuses, and non-transitory computer-readable medium described herein, the releasing may include operations, features, means, or instructions for flushing all HARQ buffers based on the first TAT associated with the first primary TAG expiring.

In some examples of the method, apparatuses, and non-transitory computer-readable medium described herein, the releasing may include operations, features, means, or instructions for flushing all HARQ buffers based on the first TAT expiring and the second TAT expiring.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAG being a primary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAG being a secondary TAG.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAT and the second TAT both expiring, where the first TAG may be a primary TAG, and the second TAG may be a secondary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAT and the second TAT both expiring, where the first TAG may be a primary TAG, and the second TAG may be a secondary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAT and the second TAT both expiring, where both the first TAG and the second TAG may be secondary TAGs.

Some examples of the method, apparatuses, and non-transitory computer-readable medium described herein may further include operations, features, means, or instructions for releasing the second one or more network parameters at the cell-level or at the TRP-level based on a UE capability to support retransmission across different TRPs.

Some examples of the method, apparatuses, and non-transitory computer-readable medium described herein may further include operations, features, means, or instructions for releasing the second one or more network parameters at the TRP-level based on supporting retransmission across different TRPs.

Some examples of the method, apparatuses, and non-transitory computer-readable medium described herein may further include operations, features, means, or instructions for releasing the second one or more network parameters at the cell-level based on supporting retransmission across different TRPs.

Some examples of the method, apparatuses, and non-transitory computer-readable medium described herein may further include operations, features, means, or instructions for releasing the second one or more network parameters at the cell-level based on not supporting retransmission across different TRP the and the first TAT and the second TAT both expiring.

In some examples of the method, apparatuses, and non-transitory computer-readable medium described herein, the releasing may include operations, features, means, or instructions for releasing the second one or more network parameters at the cell-level or at the TRP-level based on the control message indicating an acknowledgment feedback mode for a cell group including the serving cell.

In some examples of the method, apparatuses, and non-transitory computer-readable medium described herein, the releasing may include operations, features, means, or instructions for releasing the second one or more network parameters at the TRP-level based on the control message indicating a joint acknowledgment feedback mode for a cell group including the serving cell.

In some examples of the method, apparatuses, and non-transitory computer-readable medium described herein, the releasing may include operations, features, means, or instructions for releasing the second one or more network parameters at the cell-level based on the control message indicating a joint acknowledgment feedback mode for the cell group that the serving cell belong to.

In some examples of the method, apparatuses, and non-transitory computer-readable medium described herein, releasing the first one or more network parameters may include operations, features, means, or instructions for flushing all downlink HARQ buffers, flushing all uplink HARQ buffers, releasing uplink control channel resources, releasing sounding reference signal resources, releasing configured downlink assignments, releasing configured uplink grants, releasing uplink shared channel resources for semi-persistent channel state information reporting, or any combination thereof.

In some examples of the method, apparatuses, and non-transitory computer-readable medium described herein, releasing the second one or more network parameters may include operations, features, means, or instructions for flushing all downlink HARQ buffers, flushing all uplink HARQ buffers, or any combination thereof.

In some examples of the method, apparatuses, and non-transitory computer-readable medium described herein, the first TRP may be corresponding to a first control resource set pool index value or a first set of unified transmission configuration indicator states or spatial relations, and the second TRP may be corresponding to a second control resource set pool index value or a second set of unified transmission configuration indicator states or spatial relations.

A method for wireless communications at a network entity is described. The method may include transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, releasing a first one or more network parameters at a TRP-level or a second one or more network parameters at a cell-level, or both, based on the first TAT expiring, and communicating with a UE via the first TRP or the second TRP, or both, based on the first TAT expiring.

An apparatus for wireless communications at a network entity is described. The apparatus may include a processor, memory coupled with the processor, and instructions stored in the memory. The instructions may be executable by the processor to cause the apparatus to transmit a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, release a first one or more network parameters at a TRP-level or a second one or more network parameters at a cell-level, or both, based on the first TAT expiring, and communicate with a UE via the first TRP or the second TRP, or both, based on the first TAT expiring.

Another apparatus for wireless communications at a network entity is described. The apparatus may include means for transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, means for releasing a first one or more network parameters at a TRP-level or a second one or more network parameters at a cell-level, or both, based on the first TAT expiring, and means for communicating with a UE via the first TRP or the second TRP, or both, based on the first TAT expiring.

A non-transitory computer-readable medium storing code for wireless communications at a network entity is described. The code may include instructions executable by a processor to transmit a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell, release a first one or more network parameters at a TRP-level or a second one or more network parameters at a cell-level, or both, based on the first TAT expiring, and communicate with a UE via the first TRP or the second TRP, or both, based on the first TAT expiring.

In some examples of the method, apparatuses, and non-transitory computer-readable medium described herein, the releasing may include operations, features, means, or instructions for releasing the first one or more network parameters at the TRP-level for the first TRP based on the first TAG being a first primary TAG and the second TAG being a second primary TAG.

In some examples of the method, apparatuses, and non-transitory computer-readable medium described herein, the first one or more network parameters may be released for all serving cells in a cell group associated with the first TRP.

In some examples of the method, apparatuses, and non-transitory computer-readable medium described herein, the communicating may include operations, features, means, or instructions for communicating with the UE via the second TRP based on the second one or more network parameters associated with the second TRP.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAG being a first primary TAG and the second TAG being a second primary TAG.

In some examples of the method, apparatuses, and non-transitory computer-readable medium described herein, the releasing may include operations, features, means, or instructions for flushing all HARQ buffers based on the first TAT associated with the first primary TAG expiring.

In some examples of the method, apparatuses, and non-transitory computer-readable medium described herein, the releasing may include operations, features, means, or instructions for flushing all HARQ buffers based on the first TAT expiring and the second TAT expiring.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAG being a primary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAG being a secondary TAG.

In some examples of the method, apparatuses, and non-transitory computer-readable medium described herein, the releasing may include operations, features, means, or instructions for releasing the second one or more network parameters at the cell-level for each TRP across all serving cells of a same cell group based on the first TAT and the second TAT both expiring, where the first TAG may be a primary TAG, and the second TAG may be a secondary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAT and the second TAT both expiring, where the first TAG may be a primary TAG, and the second TAG may be a secondary TAG.

In some examples of the method, apparatuses, and non-transitory computer-readable medium described herein, the releasing may include operations, features, means, or instructions for releasing the second one or more network parameters at the cell-level for each TRP across serving cells associated with the first TAG based on the first TAT and the second TAT both expiring, where both the first TAG and the second TAG may be secondary TAGs.

In some examples of the method, apparatuses, and non-transitory computer-readable medium described herein, the releasing may include operations, features, means, or instructions for releasing the second one or more network parameters at the cell-level or at the TRP-level based on a UE capability to support retransmission across different TRPs.

In some examples of the method, apparatuses, and non-transitory computer-readable medium described herein, the releasing may include operations, features, means, or instructions for releasing the second one or more network parameters at the cell-level or the TRP-level based on the control message indicating an acknowledgment feedback mode for a cell group including the serving cell.

In some examples of the method, apparatuses, and non-transitory computer-readable medium described herein, the releasing may include operations, features, means, or instructions for releasing the second one or more network parameters at the TRP-level based on the control message indicating a joint acknowledgment feedback mode for a cell group including the serving cell.

### BRIEF DESCRIPTION OF THE DRAWINGS

FIG. 1 illustrates an example of a wireless communications system that supports techniques for uplink time alignment timer (TAT) management for multiple transmission-reception points (TRPs) in accordance with one or more aspects of the present disclosure.

FIG. 2 illustrates an example of a wireless communications system that supports techniques for uplink TAT management for multiple TRPs in accordance with one or more aspects of the present disclosure.

FIG. 3 illustrates an example of a network parameter release scheme that supports techniques for uplink TAT management for multiple TRPs in accordance with one or more aspects of the present disclosure.

FIG. 4 illustrates an example of a network parameter release scheme that supports techniques for uplink TAT management for multiple TRPs in accordance with one or more aspects of the present disclosure.

FIG. 5 illustrates an example of a process flow that supports techniques for uplink TAT management for multiple TRPs in accordance with one or more aspects of the present disclosure.

FIGS. 6 and 7 illustrate block diagrams of devices that support techniques for uplink TAT management for multiple TRPs in accordance with one or more aspects of the present disclosure.

FIG. 8 illustrates a block diagram of a communications manager that supports techniques for uplink TAT management for multiple TRPs in accordance with one or more aspects of the present disclosure.

FIG. 9 illustrates a diagram of a system including a device that supports techniques for uplink TAT management for multiple TRPs in accordance with one or more aspects of the present disclosure.

FIGS. 10 and 11 illustrate block diagrams of devices that support techniques for uplink TAT management for multiple TRPs in accordance with one or more aspects of the present disclosure.

FIG. 12 illustrates a block diagram of a communications manager that supports techniques for uplink TAT management for multiple TRPs in accordance with one or more aspects of the present disclosure.

FIG. 13 illustrates a diagram of a system including a device that supports techniques for uplink TAT management for multiple TRPs in accordance with one or more aspects of the present disclosure.

FIGS. 14 through 17 illustrate flowcharts showing methods that support techniques for uplink TAT management for multiple TRPs in accordance with one or more aspects of the present disclosure.

### DETAILED DESCRIPTION

A user equipment (UE) may be configured with a timing advance group (TAG) including one or more serving cells that have aligned timing. The UE may be configured with a time alignment timer (TAT) associated with the TAG. While the TAT is active or running, a medium access control (MAC) entity (e.g., at the UE or a network entity) may consider the serving cells belonging to the TAG to be uplink time aligned. In some systems, when a TAT expires, the MAC entity may not consider the serving cells to be uplink time aligned, and the UE may release network parameters (e.g., MAC-level network parameters). For example, if a TAT associated with a primary TAG expires, the UE may flush all hybrid automatic repeat request (HARQ) buffers for all serving cells, notify a Radio Resource Control (RRC) layer to release uplink control channel resources and sounding reference signal (SRS) resources for all serving cells (e.g., if configured), clear any configured downlink assignments and configured uplink grants, and consider any additional running TATs to be expired.

Some systems may support communications using multiple transmission-reception points (TRPs). For example, a UE may communicate with a network or a network entity via multiple TRPs. For some systems utilizing multi-TRP communications, a UE may be configured with multiple TAGs per serving cell. For example, for some multi-TRP systems, the UE may be configured with two TAGs per serving cell. Current techniques for UE behavior to release network parameters when a TAT expires may be inefficient if the UE is configured with multiple TAGs per serving cell.

Wireless communications systems described herein may support TRP-level operation and cell-level operation for TAG and TAT management, including mixed TRP-level and cell-level operation. For example, a UE may be configured with two TAGs for a serving cell, where each TAG is configured with an individual TAT. The UE may perform mixed TRP-level operation and cell-level operation when one or more TATs for the two TAGs expires. For example, the UE may perform TRP-level operation, such as releasing resources or clearing configured assignments, when at least one or more TAT expires. The UE may perform cell-level operation, such as flushing a cell-level HARQ buffer, based on the at least one TAT expiring.

For example, a UE may be configured with two primary TAGs for a primary serving cell, where each primary TAG is associated with a respective TRP. If a TAT for one of the two primary TAGs expires, the UE may perform TRP-level operation for the given TRP across all serving cells in the same cell group. For example, the UE may flush HARQ buffers, notify RRC to release uplink control channels and SRS (e.g., if configured), clear configured downlink assignments and configured uplink grants, clear physical uplink shared channel (PUSCH) resources for semi-persistent channel state information (CSI) reporting, or maintain a timing advance parameter or configuration, or any combination thereof, for the TAG associated with the expired TAT across all serving cells in a same cell group. The UE may perform cell-level operations in addition to, or alternatively to, the TRP-level operation. For example, if one of the TATs associated with the two primary TAGs is expired, the UE may flush all HARQ buffers for all TRPs across all serving cells in the same cell group. In some other examples, the UE may flush all HARQ buffers for all TRPs across all serving cells in the same cell group if both primary TAGs in the primary cell expire (e.g., and may not flush any HARQ buffers if just one TAG is expired).

Aspects of the disclosure are initially described in the context of wireless communications systems. Aspects of the disclosure are further illustrated by and described with reference to apparatus diagrams, system diagrams, and flowcharts that relate to techniques for uplink TAT management for multiple TRPs.

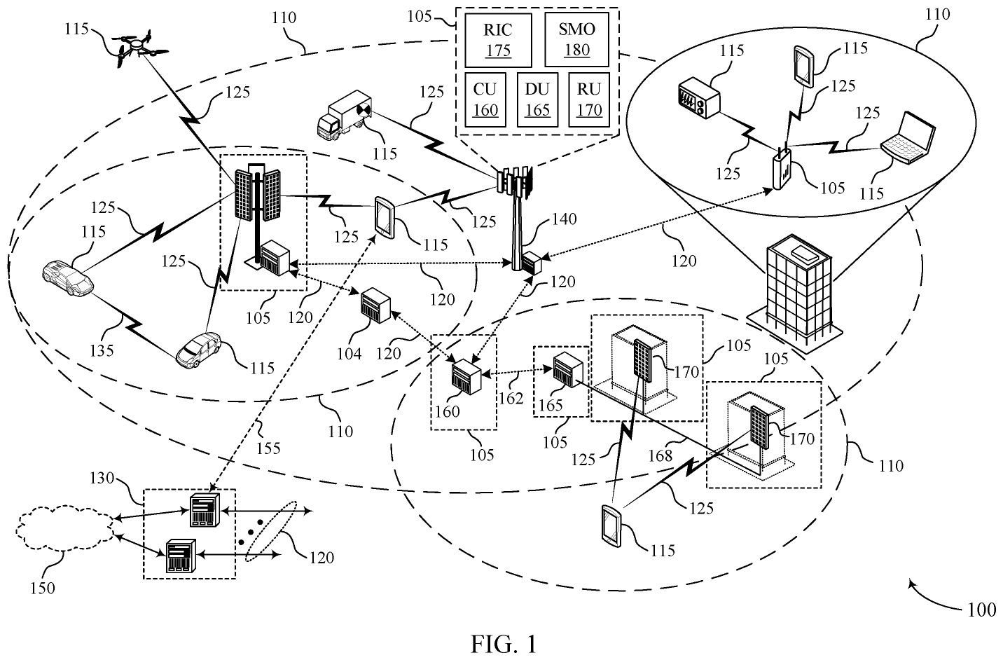

FIG. 1 illustrates an example of a wireless communications system 100 that supports techniques for uplink TAT management for multiple TRPs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for uplink TAT management for multiple TRPs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some systems, a UE 115 may be configured with a TAG including one or more serving cells that have aligned timing. The UE 115 may be configured with a TAT associated with the TAG. While the TAT is active or running, a MAC entity (e.g., at the UE 115 or a network entity 105, or both) may consider the serving cells belonging to the TAG to be uplink time aligned. In some systems, when a TAT expires, the MAC entity may not consider the serving cells to be uplink time aligned, and the UE 115 may release network parameters (e.g., MAC-level network parameters).

For example, if a TAT associated with a primary TAG expires, the UE 115 may flush all HARQ buffers for all serving cells, notify an RRC layer to release uplink control channel resources and SRS resources for all serving cells (e.g., if configured), clear any configured downlink assignments and configured uplink grants, and consider any additional running TATs to be expired.

If a TAT associated with a secondary TAG expires in these systems, the UE 115 may release some network parameters for serving cells belonging to the secondary TAG. For example, the UE 115 may, for each serving cell belonging to the TAG, flush HARQ buffers, notify the RRC layer to release physical uplink control channel (PUCCH) resources and SRS resources (e.g., if configured), clear any configured downlink assignments and configured uplink grants, clear any PUSCH resources for semi-persistent CSI report, and maintain timing advance information of the TAG if the secondary TAG expires.

Some systems may support communications using multiple TRPs. For example, a UE may communicate with a network or a network entity via multiple TRPs. In some examples, a system may support multi-DCI based multi-TRP communications, where a retransmission may be scheduled by a different TRP, or a cell with a different control resource set pool index than the cell scheduling the initial transmission. In some examples, the UE 115 may transmit a capability message indicating whether the UE 115 supports multi-DCI based multi-TRP communications. For example, the UE 115 may indicate whether the UE 115 supports retransmission via a different TRP than the originally scheduling TRP. A UE 115 which supports multi-DCI based multi-TRP may include, for example, a parameter such as multiDCI-multiTRP-r16 in the capability message.

For some systems utilizing multi-TRP communications, a UE 115 may be configured with multiple TAGs per serving cell. For example, for some multi-TRP systems, the UE 115 may be configured with two TAGs per serving cell. Current techniques for UE behavior to release network parameters when a TAT expires may be inefficient if the UE 115 is configured with multiple TAGs per serving cell.

For systems supporting multi-DCI based multi-TRP, a UE may be configured with two separate TAGs for a serving cell. For example, a primary cell, or a primary cell of a secondary cell group, referred to as a SpCell, may be configured with two separate TAGs. In some examples, the primary cell may include a primary TAG and a secondary TAG or two primary TAGs. For example, a UE 115 may communicate with a first TRP and a second TRP via a primary cell, such as a via a first component carrier in a carrier aggregation scheme.

Wireless communications systems described herein, such as the wireless communications system 100, may support TRP-level operation and cell-level operation for TAG and TAT management, including mixed TRP-level and cell-level operation. For example, a UE 115 may be configured with two TAGs for a serving cell, where each TAG is configured with an individual TAT. The UE 115 may perform mixed TRP-level operation and cell-level operation when one or more TATs for the two TAGs expire. For example, the UE 115 may perform TRP-level operation, such as releasing resources or clearing configured assignments, when at least one or more TAT expires. The UE 115 may perform cell-level operation, such as flushing a cell-level HARQ buffer, based on the at least one TAT expiring.

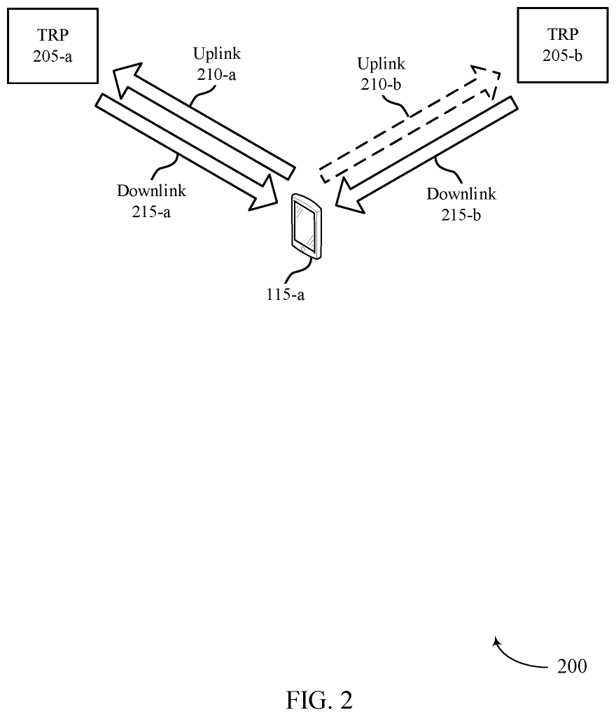

FIG. 2 illustrates an example of a wireless communications system 200 that supports techniques for uplink TAT management for multiple TRPs in accordance with one or more aspects of the present disclosure. The wireless communications system 200 may include a UE 115-a and one or more TRPs 205, such as a TRP 205-a and a TRP 205-b. A TRP 205 may include aspects of a network entity 105 or its components.

The UE 115-a may support communications with one or more network entities 105 via multiple TRPs 205. In some examples, the UE 115-a may be configured for uplink and downlink communications via the TRP 205-a or the TRP 205-b, or both. For example, the UE 115-a may transmit uplink signaling, such as uplink shared channel signaling, to the TRP 205-a via an uplink 210-a and receive downlink signaling, such as downlink control channel signaling, from the TRP 205-a via a downlink 215-a. The UE 115-a may receive downlink signaling, such as downlink control channel signaling, from the TRP 205-b via a downlink 215-b. In some examples, the UE 115-a may transmit uplink signaling, such as uplink shared channel signaling, to the TRP 205-b via an uplink 210-b.

In some examples, a TRP 205 may correspond to a control resource set pool index. For example, the TRP 205 may correspond to a control resource set pool index if an association between uplink channels/reference signals and a TAG is determined based on a control resource set pool index value associated with the uplink channels/reference signals. For example, the TRP 205-a may be associated with a first control resource set pool index, and the TRP 205-b may be associated with a second control resource set pool index. In some examples, a TRP 205 may be associated with a set of unified transmission configuration indicator (TCI) states or spatial relations, such as if an association between uplink channels/reference signals and a TAG is determined based on the TCI state or spatial relation associated with the uplink channels/reference signals. For example, the TRP 205-a may be associated with a first set of TCI states or a first set of spatial relations, and the TRP 205-b may be associated with a second set of TCI states or a second set of spatial relation.

In some examples, the UE 115-a may indicate whether to support to receive a retransmission of a message from a different TRP 205 than the TRP 205 that scheduled an initial transmission of the message. For example, the UE 115-a may be configured for, or support, multi-DCI multi-TRP communications. The UE 115-a may receive control signaling scheduling a message via a first TRP 205 (e.g., the TRP 205-a) and receive a retransmission of the message via a second TRP 205 (e.g., the TRP 205-b) if receipt of the initial transmission was unsuccessful.

The UE 115-a may be configured with two TAGs for a serving cell based on supporting multi-TRP communications. For example, a primary cell, or an SpCell, may be configured with two separate TAGs. In some examples, the primary cell may include a primary TAG and a secondary TAG, two primary TAGs. For example, the UE 115-a may communicate with TRP 205-a and the TRP 205-b via a primary cell, such as via a first component carrier in a carrier aggregation scheme. In some examples, the UE 115-a may communicate with additional TRPs 205 via additional serving cells or component carriers.

The wireless communications system 200 may support TRP-level operation and cell-level operation for TAG and TAT management, including mixed TRP-level and cell-level operation. For example, the UE 115-a may be configured with two TAGs for a serving cell, where each TAG is configured with an individual TAT. The UE 115-a may perform mixed TRP-level operation and cell-level operation when one or more TATs for the two TAGs expire. For example, the UE 115 may perform TRP-level operation, such as releasing uplink resources or clearing configured assignments or grants, when at least one or more TAT expires. The UE 115-a may perform cell-level operation, such as flushing a cell-level HARQ buffer, based on the at least one TAT expiring.

For example, the UE 115-a may be configured with two primary TAGs for a primary serving cell or a primary secondary cell, where each primary TAG is associated with a respective TRP. In some examples, if a TAT for one of the two primary TAGs expires, and if the primary TAG associated with the expired TAT is associated with a given TRP 205, the UE 115-a may perform TRP-level operation for the given TRP across all serving cells in the same cell group. For example, the UE 115-a may flush HARQ buffers, notify RRC to release uplink control channels and SRS (e.g., if configured), clear configured downlink assignments and configured uplink grants, clear PUSCH resources for semi-persistent CSI reporting, or maintain a timing advance value of all TAGS, or any combination thereof, for the TRP associated with the expired TAT across all serving cells in a same cell group.

In some examples, the UE 115-a may perform mixed TRP-level and cell-level operation when a TAT expires. For example, the UE 115-a may perform TRP-level operation for a TRP 205 across all serving cells in a same cell group if a TAT for one of the two primary TAGs expires and the primary TAG associated with the expired TAT is associated with a TRP 205. For example, the TRP-level operation when the TAT expires may include notifying RRC to release PUCCH (e.g., if configured), notifying RRC to release SRS (e.g., if configured), clearing any configured downlink assignments and configured uplink grants, clearing any PUSCH resources for semi-persistent CSI reporting, and maintaining a timing advance value (e.g., NTA) of TAGs associated with the given TRP 205. Additionally, the UE 115-a may perform cell-level operations for the given TRP 205 across serving cells in a same cell group. In some examples, the cell-level operation may include flushing HARQ buffers (e.g., all HARQ buffers for the serving cells in the same cell group) if at least one TAT associated with the two primary TAGs expires. The UE 115-a may flush HARQ buffers if at least one TAT expires if, for example, the UE 115-a cannot distinguish which HARQ process identifier is associated with which TRP 205. In some examples, the cell-level operation may include flushing HARQ buffers (e.g., all HARQ buffers for the serving cells in the same cell group) if both TATs associated with the two primary TAGs expire (e.g., the UE 115-a may not flush HARQ buffers if one TAT associated with the two primary TAGs expires).

In some examples, the UE 115-a may be configured with a component carrier with two TAGs. Each TAG may be configured with an individual TAT, and the UE 115-a may perform mixed TRP-level operation and cell-level operation.

For example, a TAT for one of the two TAGs associated with a TRP 205 may expire. The UE 115-a may perform TRP-level operation, including notifying RRC to release PUCCH for the TRP 205 (e.g., if configured), notifying RRC to release SRS for the TRP 205 (e.g., if configured), clearing any configured downlink assignments and configured uplink grants for the TRP 205, clearing any PUSCH resources for semi-persistent CSI reporting for the TRP 205, and maintaining a timing advance value (e.g., NTA) of the TAG associated with the TRP 205. If the TAT is associated with a primary TAG, the TRP-level operation may be performed for the TRP 205 across serving cells (e.g., all serving cells) in the same cell group. If the TAT is associated with a secondary TAG, the TRP-level operation may be performed for any serving cell that is configured with a single TAG same as the secondary TAG and for any TRP associated with the secondary TAG in the serving cell that is configured with two TAGs (e.g., where one of them is the same as the secondary TAG).

Additionally, when one or more TATs for the two TAGs associated with the component carrier expire, the UE 115-a may perform cell-level operation for HARQ buffer flushing. In some examples, the UE 115-a may perform HARQ buffer flushing if at least one of the TATs associated with the two TAGs of the component carrier expires. If the TAG associated with the expired TAT(s) include a primary TAG, the UE 115-a may flush all HARQ buffers for all TRPs across all serving cells in the same cell group. For example, the UE 115-a may perform cell-level HARQ buffer flushing, including flushing all HARQ buffers for all TRPs 205 across serving cells in the same cell group, if a TAG associated with the at least one expired TAT is a primary TAG. In some examples, if the TAG associated with the expired TAT(s) only include secondary TAG, the UE 115-a may perform cell-level HARQ bluffer flushing, including flushing all HARQ buffers for the serving cells including the secondary TAG.

In some examples, the UE 115-a may perform HARQ buffer flushing if both TATs associated with the two TAGs of the component carrier expire. For example if just one TAT associated with one of the two TAGs of the component carrier expires, the UE 115-a may not flush any HARQ buffers. In some examples, if both TAGs associated with the component carrier are primary TAGs or if one of the two TAGs is a primary tag and only one of the TAGs on a primary cell is defined as a primary TAG, the UE 115-a may perform cell-level HARQ buffer flushing, including flushing all HARQ buffers for all TRPs across all serving cells in the same cell group. If the two TAGs are both secondary TAGs, or if one of the two TAGs is a primary TAG and both TAGs on a primary cell are defined as PTAG, the UE 115-a may perform cell-level HARQ buffer flushing, including flushing all HARQ buffers for the serving cells that include the two TAGs.

In some examples, the UE 115-a may perform TRP-level operation or cell-level operation, or both, based on a capability of the UE 115-a. For example, if at least one serving cell is configured with two TAGs and each TAG is configured with an individual TAT, the UE behavior (e.g., cell-level operation, TRP-level operation, or mixed operation) may be based on whether the UE 115-a indicates support for retransmission across different TRPs. In some examples, the UE 115-a may indicate support for retransmission across different TRPs based on indicating support for retransmission across different control resource set pools using multi-DCI, multi-TRP techniques.

For example, the UE 115-a may transmit a capability message indicating the UE 115-a does not support retransmission across different TRPs. For example, if the UE 115-a indicates a parameter supportRetx-Diff-CoresetPool-Multi-DCI-TRP-r16, retransmission scheduled by a different control resource set pool index for multi-DCI, multi-TRP may not be supported by the UE 115-a. In some examples, if a TAT for one of the two TAGs expires, the UE 115-a may perform TRP-level HARQ buffer flushing. If the TAT is associated with a primary TAG, and the primary TAG is associated with a given TRP 205, the UE 115-a may perform TRP-level HARQ buffer flushing, including flushing all HARQ buffers for the given TRP across all serving cells in the same group. If the TAT is associated with a secondary TAG, TRP-level HARQ buffer flushing may include flushing all HARQ buffers for any serving cell that is configured with a single TAG the same as the secondary TAG and for any TRP associated with the secondary TAG in the serving cell that is configured with the two TAGs (e.g., including the secondary TAG). In some examples, the UE 115-a may perform cell-level operation for HARQ buffer flushing when at least one of the TATs associated with the two TAGs expires. For example, if the TAGs associated with the expired TAT(s) includes a primary TAG, the UE 115-a may flush all HARQ buffers for all TRPs across all serving cells in the same cell group. If the TAG(s) associated with the at least one TAT includes a secondary TAG and not include a primary TAG, the UE 115-a may flush all HARQ buffers for the serving cells that include the secondary TAG.

If the UE 115-a supports for retransmission across different TRPs, the UE 115-a may perform cell-level HARQ buffer flushing when both TATs are expired. For example, if just one TAT associated with the two TAGs of the component carrier expires, and the UE 115-a supports retransmission across different TRPs, the UE 115-a may not flush HARQ buffers. If both TAGs associated with a component carrier are primary TAGs or if one of the two TAGs is a primary tag and only one of the TAGs on a primary cell is defined as primary TAG, the UE 115-a may perform cell-level HARQ buffer flushing, including flushing all HARQ buffers for all TRPs across all serving cells in the same cell group. If the two TAGs are both secondary TAGs, or if one of the two TAGs is a primary TAG and both TAGs on primary cell are defined as primary TAGs, the UE 115-a may perform cell-level HARQ buffer flushing, including flushing all HARQ buffers for the serving cells that include the two TAGs.

In some examples, if at least one serving cell is configured with two TAGs and each TAG is configured with an individual TAT, the UE may flush HARQ buffers based on an acknowledgment feedback mode. For example, the UE 115-a may perform TRP-level operation or cell-level operation, or both, based on whether the serving cells or TAGs are configured for individual/separate feedback or configured for joint feedback. For example, if separate acknowledgment feedback mode is configured, the UE 115-a may perform TRP-level HARQ buffer flushing for downlink if a TAT for one of the two TAGs expires. In some examples, the UE 115-a may perform cell-level HARQ buffer flushing for downlink if at least one TAT associated with the two TAGs is expired. In some examples, the UE 115-a may perform cell-level HARQ buffer flushing for downlink if both TATs associated with the two TAGs is expired.

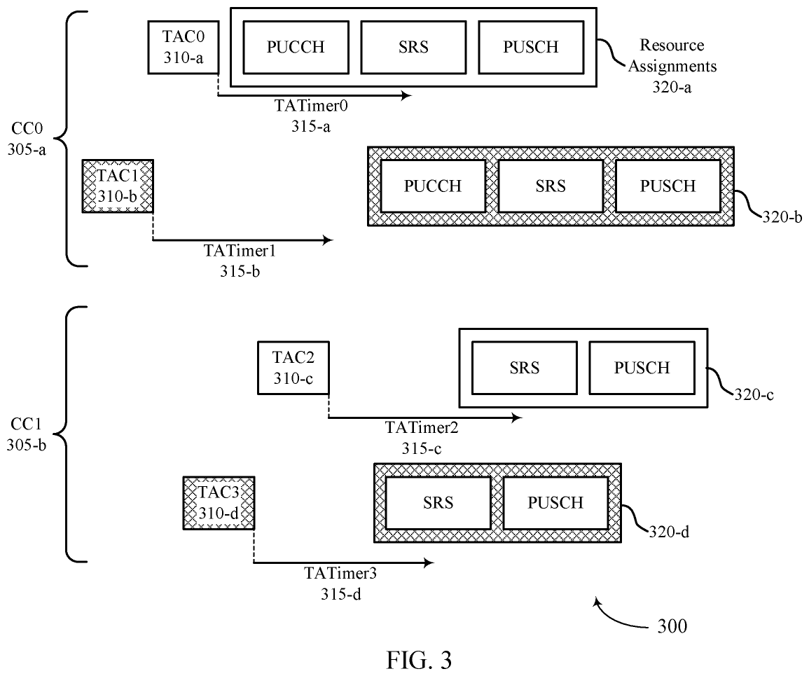

FIG. 3 illustrates an example of a network parameter release scheme 300 that supports techniques for uplink TAT management for multiple TRPs in accordance with one or more aspects of the present disclosure.

A UE 115 may be configured to communicate via multiple TRPs. In some examples, different TRPs may be associated with different TAGs. The UE 115 may be configured with a first component carrier 305-a and a second component carrier 305-b. The first component carrier 305-a may include a first TAG and a second TAG, such as a TAG0 and a TAG1. In some examples, the first component carrier 305-a may include two primary TAGs. For example, TAG0 and TAG1 may each be an example of a primary TAG. In some examples, the first component carrier 305-a may be an example of a primary cell or an SpCell. The second component carrier 305-b may include a third TAG (e.g., TAG2) and a fourth TAG (e.g., TAG3). The first TAG and the third TAG may each be associated with a first TRP, and the second TAG and the fourth TAG may each be associated with a second TRP.

The UE 115 may receive a timing advance command (TAC) 310 and start a TAT 315 for a TAG. For example, the UE 115 may receive a TAC 310-a and start a TAT 315-a for TAG0. While the TAT 315 for a TAG is running, the UE 115 may consider uplink channels for the TAG to be time aligned. The UE 115 may also receive a TAC 310-b and start a TAT 315-b for TAG1, a TAC 310-c indicating to start a TAT 315-c for TAG2 in the second component carrier 305-b, and a TAC 310-d indicating to start a TAT 315-d for TAG3 in the second component carrier 305-b.

The UE 115 may be configured with a resource assignment 320-a for the first TAG and a resource assignment 320-b for the second TAG in the first component carrier 305-a. The resource assignment 320-a may include PUCCH resources, SRS resources, and PUSCH resources for transmission to the first TRP, and the resource assignment 320-b may include PUCCH resources, SRS resources, and PUSCH resources for transmission to the second TRP. Similarly, the UE 115 may be configured with a resource assignment 320-c for the third TAG and a resource assignment 320-d for the fourth TAG in the second component carrier 305-b. The resource assignment 320-c may include SRS resources and PUSCH resources for transmission to the first TRP, and the resource assignment 320-d may include SRS resources and PUSCH resources for transmission to the second TRP.

In some examples, a TAT 315 may expire, and the UE 115 may perform cell-level or TRP-level operation to release network parameters based on the TAT 315 expiring. For example, the TAT 315-b may expire, and the UE 115 may perform MAC entity release for the second TRP across all component carriers (e.g., the first component carrier 305-a and the second component carrier 305-b). For example, based on the TAT 315-b, associated with a primary TAG, expiring, the UE 115 may perform TRP-level operation for the given TRP across all serving cells in the same cell group. For example, the UE 115 may release PUCCH, SRS, and PUSCH resources for the second TRP (e.g., TRP 205-b) across all serving cells, releasing the resource assignment 320-b and the resource assignment 320-d. While the UE 115 has release the resource assignments 320 associated with the second TRP, the UE 115 may still communicate with the first TRP (e.g., TRP 205-a) via resource assignments 320 associated with the first TRP and associated TAGs. For example, the UE 115 may transmit to the first TRP via the resource assignment 320-a and the resource assignment 320-c.

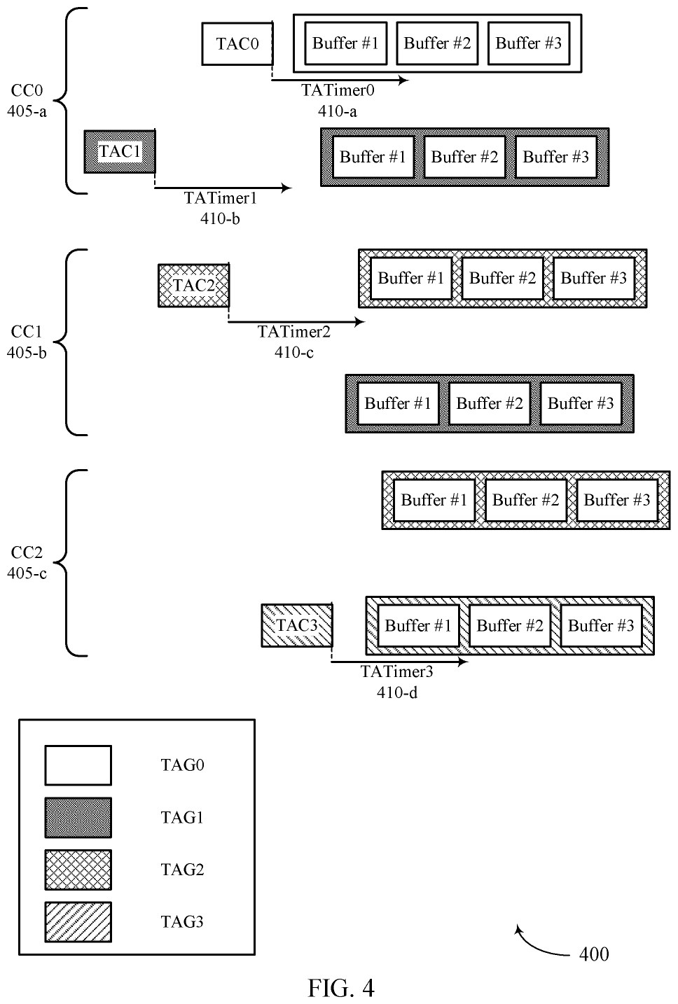

FIG. 4 illustrates an example of a network parameter release scheme 400 that supports techniques for uplink TAT management for multiple TRPs in accordance with one or more aspects of the present disclosure.

A UE 115 may be configured to communicate via multiple TRPs. In some examples, different TRPs may be associated with different TAGs. The UE 115 may be configured with a first component carrier 405-a, a second component carrier 405-b, and a third component carrier 405-c. The first component carrier 405-a may include a first TAG and a second TAG, such as a TAG0 and a TAG1. In some examples, the first component carrier 405-a may include two primary TAGs. For example, TAG0 and TAG1 may each be an example of a primary TAG. In some examples, the first component carrier 405-a may be an example of a primary cell or an SpCell. The second component carrier 405-b may include a third TAG (e.g., TAG2) and the second TAG (e.g., TAG1). The third component carrier 405-c may include the third TAG (e.g., TAG2) and a fourth TAG (e.g., TAG3). In some examples, the first TAG may be associated with a first TRP, the second TAG may be associated with a second TRP on the first component carrier 405-a and the second component carrier 405-b, the third TAG may be associated with a first TRP on the second component carrier 405-b and the third component carrier 405-c, and the fourth TAG may be associated with a second TRP on the third component carrier 405-c.

The UE 115 may receive a TAC and start a TAT 410 for a TAG. For example, the UE 115 may receive a first TAC and start a TAT 410-a for TAG0. While the TAT 410 for a TAG is running, the UE 115 may consider uplink channels for the TAG to be time aligned. The UE 115 may also receive a second TAC and start a TAT 410-b for TAG1, a third TAC and start a TAT 410-c for TAG2, and a fourth TAC and start a TAT 410-d for TAG3.

In some examples, a TAT 410 may expire, and the UE 115 may perform cell-level or TRP-level operation, or both, to release network parameters based on the TAT 410 expiring.

In some examples, if a TAT associated with a primary TAG expires, the UE 115 may flush HARQ buffers across all component carriers in a same cell group. For example, if TAT 410-b (e.g., associated with primary TAG1) expires, the UE 115 may flush all HARQ buffers across all component carriers in a same cell group. For example, the UE 115 may flush all HARQ buffers across the first component carrier 405-a, the second component carrier 405-b, and the third component carrier 405-c.

In some examples, if a TAT associated with a secondary TAG expires, the UE 115 may flush all HARQ buffers for all component carriers that include that secondary TAG. For example, TAT 410-c may expire, and the UE 115 may flush all HARQ buffers for the component carriers that include TAG2, including the second component carrier 405-b and the third component carrier 405-c.

In some examples, the UE 115 may flush HARQ buffers if both TATs associated with two TAGs of a component carrier expire. For example, if TAT 410-b (e.g., associated with primary TAG1) and TAT 410-c (e.g., associated with secondary TAG2) expire, the UE 115 may flush all HARQ buffers for the component carriers that include both TAG1 and TAG2, such as the second component carrier 405-b.

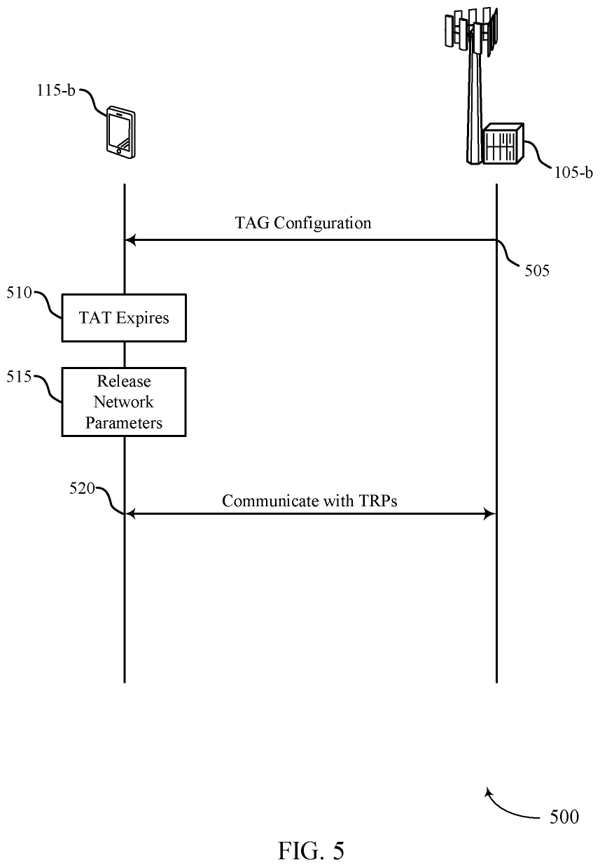

FIG. 5 illustrates an example of a process flow 500 that supports techniques for uplink TAT management for multiple TRPs in accordance with one or more aspects of the present disclosure. The process flow may be implemented by a UE 115-b and a network entity 105-b, which may be respective examples of a UE 115 and a network entity 105 as described herein. The network entity 105 may include, or include aspects of, multiple TRPs, such as a TRP 205 as described with reference to FIG. 2. The UE 115-b may communicate with the network entity 105-b via the multiple TRPs.

At 505, the UE 115-b may receive, from the network entity 105-b, a control message indicating a first TAG and a first TAT associated with the first TAG for a serving cell. In some examples, the control message may indicate a second TAG and a second TAT associated with the second TAG for the serving cell. In some examples, the first TAG may be associated with a first TRP associated with the serving cell, and the second TAG may be associated with a second TRP associated with the serving cell. In some examples, the control message may be transmitted via an RRC message.

In some examples, the first TRP may correspond to a first control resource set pool index value or a first set of unified TCI states or spatial relations. The second TRP may correspond to a second control resource set pool index value or a second set of unified TCI states or spatial relations.

At 510, one or more TATs associated with the first TAG or the second TAG, or both, may expire. For example, the first TAT associated with the first TAG may expire.

At 515, the UE 115-b may perform cell-level or TRP-level operation to release one or more network parameters based on the one or more TATs expiring. For example, the UE 115-b may release a first one or more network parameters at a TRP-level or a second one or more network parameters at a cell-level, or both, based at least in part on the first TAT expiring.

In some examples, releasing the first one or more network parameters at the TRP-level may include flushing all downlink HARQ buffers, flushing all uplink HARQ buffers, releasing uplink control channel resources, releasing sounding reference signal resources, releasing configured downlink assignments, releasing configured uplink grants, releasing uplink shared channel resources for semi-persistent channel state information reporting, or any combination thereof. In some examples, releasing the second one or more network parameters at the cell-level may include flushing all downlink HARQ buffers, flushing all uplink HARQ buffers, or both.

In some examples, the UE 115-b may release the first one or more network parameters at the TRP-level for the first TRP based on the first TAG being a first primary TAG and the second TAG being a second primary TAG. In some examples, the first one or more network parameters are released for all serving cells in a cell group associated with the first TRP.

In some examples, the UE 115-b may release the second one or more network parameters at the cell-level for each TRP across all serving cells of a same cell group based on the first TAG being a first primary TAG and the second TAG being a second primary TAG. For example, the UE 115-b may flush all HARQ buffers based on the first TAT associated with the first primary TAG expiring. In some examples, the UE 115-b may flush all HARQ buffers based on the first TAT expiring and the second TAT expiring.

In some examples, the UE 115-b may release the second one or more network parameters at the cell-level for each TRP across all serving cells of a same cell group based on the first TAG being a primary TAG. In some examples, the UE 115-b may release the second one or more network parameters at the cell-level for each TRP across serving cells associated with the first TAG based on the first TAG being a secondary TAG.

In some examples, the UE 115-b may release the second one or more network parameters at the cell-level for each TRP across all serving cells of a same cell group based on the first TAT and the second TAT both expiring, where the first TAG is a primary TAG, and the second TAG is a secondary TAG. In some examples, the UE 115-b may release the second one or more network parameters at the cell-level for each TRP across serving cells associated with the first TAG based on the first TAT and the second TAT both expiring, where the first TAG is a primary TAG, and the second TAG is a secondary TAG. In some examples, the UE 115-b may release the second one or more network parameters at the cell-level for each TRP across serving cells associated with the first TAG based on the first TAT and the second TAT both expiring, where both the first TAG and the second TAG are secondary TAGs.

In some examples, the UE 115-b may release the second one or more network parameters at the cell-level or at the TRP-level based on a UE capability to support retransmission across different TRPs. For example, the UE 115-b may release the second one or more network parameters at the TRP-level based on supporting retransmission across different TRP. In some examples, the UE 115-b may release the second one or more network parameters at the cell-level based on supporting retransmission across different TRPs.

In some cases, the UE 115-b may not support retransmission across different TRPs. The UE 115-b may release the second one or more network parameters at the cell-level based on not supporting retransmission across different TRPs and based on the first TAT and the second TAT both expiring.

At 520, the UE 115-b may communicate with the first TRP or the second TRP, or both, based on the first TAT expiring. In some examples, the UE 115-b may release network parameters for the first TRP and communicate with the second TRP. For example, the UE 115-b may communicate with the second TRP via the second one or more network parameters associated with the second TRP.

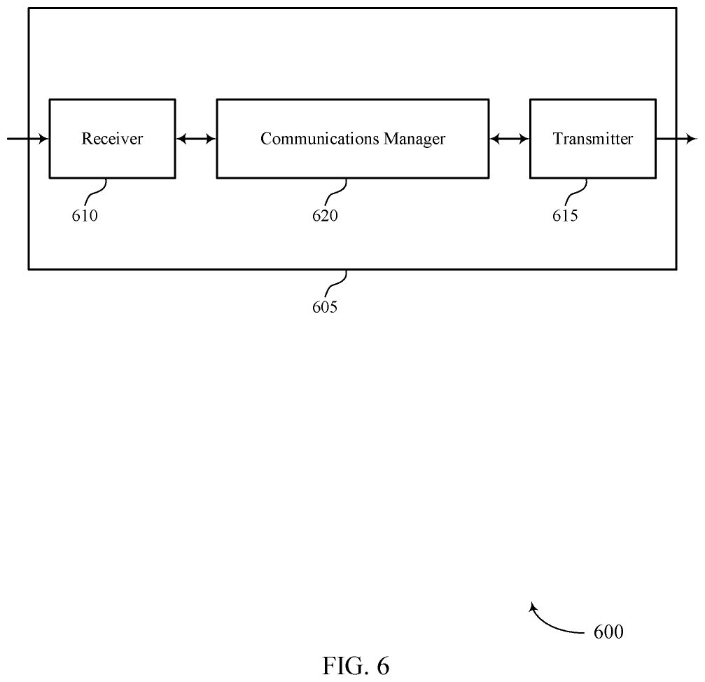

FIG. 6 illustrates a block diagram 600 of a device 605 that supports techniques for uplink TAT management for multiple TRPs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for TAG management for multiple TRPs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for TAG management for multiple TRPs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for TAG management for multiple TRPs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The communications manager 620 may be configured as or otherwise support a means for releasing a first one or more network parameters at a TRP-level or a second one or more network parameters at a cell-level, or both, based on the first TAT expiring. The communications manager 620 may be configured as or otherwise support a means for communicating with the first TRP or the second TRP, or both, based on the first TAT expiring.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

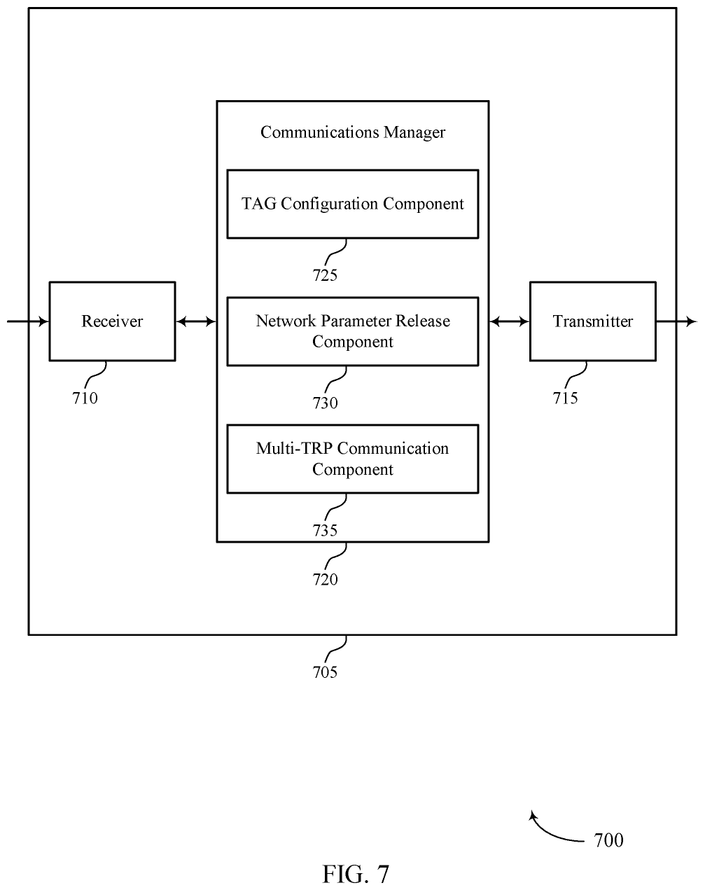

FIG. 7 illustrates a block diagram 700 of a device 705 that supports techniques for uplink TAT management for multiple TRPs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for TAG management for multiple TRPs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for TAG management for multiple TRPs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for TAG management for multiple TRPs as described herein. For example, the communications manager 720 may include a TAG configuration component 725, a network parameter release component 730, a multi-TRP communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The TAG configuration component 725 may be configured as or otherwise support a means for receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The network parameter release component 730 may be configured as or otherwise support a means for releasing a first one or more network parameters at a TRP-level or a second one or more network parameters at a cell-level, or both, based on the first TAT expiring. The multi-TRP communication component 735 may be configured as or otherwise support a means for communicating with the first TRP or the second TRP, or both, based on the first TAT expiring.

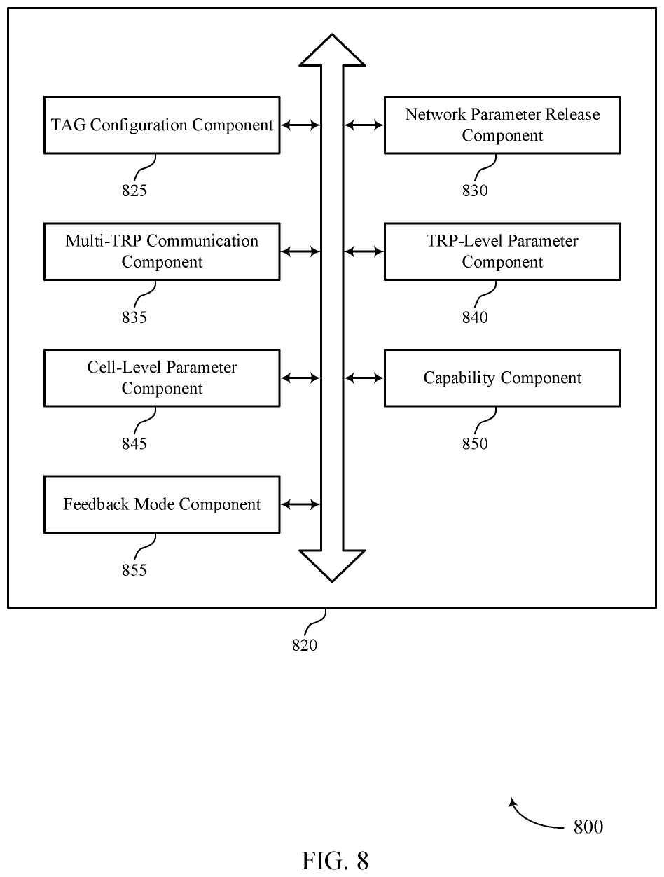

FIG. 8 illustrates a block diagram 800 of a communications manager 820 that supports techniques for uplink TAT management for multiple TRPs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for TAG management for multiple TRPs as described herein. For example, the communications manager 820 may include a TAG configuration component 825, a network parameter release component 830, a multi-TRP communication component 835, an TRP-level parameter component 840, a cell-level parameter component 845, a capability component 850, a feedback mode component 855, or any combination thereof. Each of these components may communicate, directly or indirectly, with one another (e.g., via one or more buses).

The communications manager 820 may support wireless communications at a UE in accordance with examples as disclosed herein. The TAG configuration component 825 may be configured as or otherwise support a means for receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The network parameter release component 830 may be configured as or otherwise support a means for releasing a first one or more network parameters at a TRP-level or a second one or more network parameters at a cell-level, or both, based on the first TAT expiring. The multi-TRP communication component 835 may be configured as or otherwise support a means for communicating with the first TRP or the second TRP, or both, based on the first TAT expiring.

In some examples, to support releasing, the TRP-level parameter component 840 may be configured as or otherwise support a means for releasing the first one or more network parameters at the TRP-level for the first TRP based on the first TAG being a first primary TAG and the second TAG being a second primary TAG.

In some examples, the first one or more network parameters are released for all serving cells in a cell group associated with the first TRP.

In some examples, to support communicating, the cell-level parameter component 845 may be configured as or otherwise support a means for communicating with the second TRP via the second one or more network parameters associated with the second TRP.

In some examples, to support releasing, the cell-level parameter component 845 may be configured as or otherwise support a means for releasing the second one or more network parameters at the cell-level for each TRP across all serving cells of a same cell group based on the first TAG being a first primary TAG and the second TAG being a second primary TAG.

In some examples, to support releasing, the cell-level parameter component 845 may be configured as or otherwise support a means for flushing all HARQ buffers based on the first TAT associated with the first primary TAG expiring.

In some examples, to support releasing, the cell-level parameter component 845 may be configured as or otherwise support a means for flushing all HARQ buffers based on the first TAT expiring and the second TAT expiring.

In some examples, to support releasing, the cell-level parameter component 845 may be configured as or otherwise support a means for releasing the second one or more network parameters at the cell-level for each TRP across all serving cells of a same cell group based on the first TAG being a primary TAG.

In some examples, to support releasing, the cell-level parameter component 845 may be configured as or otherwise support a means for releasing the second one or more network parameters at the cell-level for each TRP across serving cells associated with the first TAG based on the first TAG being a secondary TAG.

In some examples, to support releasing, the cell-level parameter component 845 may be configured as or otherwise support a means for releasing the second one or more network parameters at the cell-level for each TRP across all serving cells of a same cell group based on the first TAT and the second TAT both expiring, where the first TAG is a primary TAG, and the second TAG is a secondary TAG.

In some examples, to support releasing, the cell-level parameter component 845 may be configured as or otherwise support a means for releasing the second one or more network parameters at the cell-level for each TRP across serving cells associated with the first TAG based on the first TAT and the second TAT both expiring, where the first TAG is a primary TAG, and the second TAG is a secondary TAG.

In some examples, to support releasing, the cell-level parameter component 845 may be configured as or otherwise support a means for releasing the second one or more network parameters at the cell-level for each TRP across serving cells associated with the first TAG based on the first TAT and the second TAT both expiring, where both the first TAG and the second TAG are secondary TAGs.

In some examples, the capability component 850 may be configured as or otherwise support a means for releasing the second one or more network parameters at the cell-level or at the TRP-level based on a UE capability to support retransmission across different TRPs.

In some examples, the capability component 850 may be configured as or otherwise support a means for releasing the second one or more network parameters at the TRP-level based on supporting retransmission across different TRPs.

In some examples, the capability component 850 may be configured as or otherwise support a means for releasing the second one or more network parameters at the cell-level based on supporting retransmission across different TRPs.

In some examples, the capability component 850 may be configured as or otherwise support a means for releasing the second one or more network parameters at the cell-level based on not supporting retransmission across different TRP the and the first TAT and the second TAT both expiring.

In some examples, to support releasing, the feedback mode component 855 may be configured as or otherwise support a means for releasing the second one or more network parameters at the cell-level or at the TRP-level based on the control message indicating an acknowledgment feedback mode for a cell group including the serving cell.

In some examples, to support releasing, the feedback mode component 855 may be configured as or otherwise support a means for releasing the second one or more network parameters at the TRP-level based on the control message indicating a joint acknowledgment feedback mode for a cell group including the serving cell.

In some examples, to support releasing, the feedback mode component 855 may be configured as or otherwise support a means for releasing the second one or more network parameters at the cell-level based on the control message indicating a joint acknowledgment feedback mode for the cell group that the serving cell belong to.

In some examples, to support releasing the first one or more network parameters, the network parameter release component 830 may be configured as or otherwise support a means for flushing all downlink HARQ buffers, flushing all uplink HARQ buffers, releasing uplink control channel resources, releasing sounding reference signal resources, releasing configured downlink assignments, releasing configured uplink grants, releasing uplink shared channel resources for semi-persistent channel state information reporting, or any combination thereof.

In some examples, to support releasing the second one or more network parameters, the network parameter release component 830 may be configured as or otherwise support a means for flushing all downlink HARQ buffers, flushing all uplink HARQ buffers, or any combination thereof.

In some examples, the first TRP is corresponding to a first control resource set pool index value or a first set of unified transmission configuration indicator states or spatial relations, and the second TRP is corresponding to a second control resource set pool index value or a second set of unified transmission configuration indicator states or spatial relations.

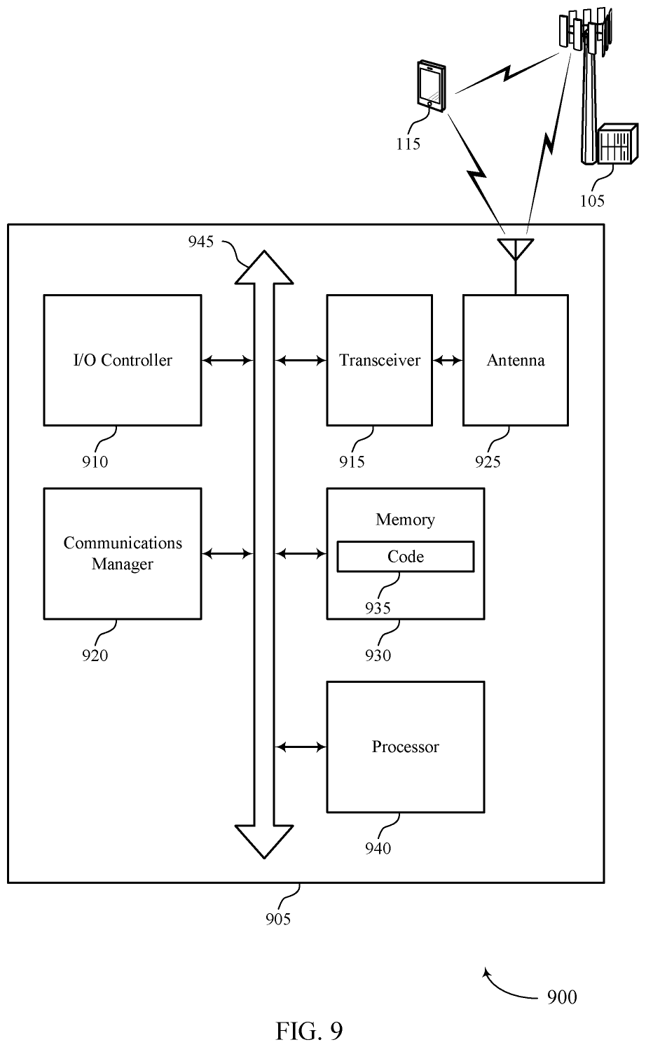

FIG. 9 illustrates a diagram of a system 900 including a device 905 that supports techniques for uplink TAT management for multiple TRPs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for TAG management for multiple TRPs). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The communications manager 920 may be configured as or otherwise support a means for releasing a first one or more network parameters at a TRP-level or a second one or more network parameters at a cell-level, or both, based on the first TAT expiring. The communications manager 920 may be configured as or otherwise support a means for communicating with the first TRP or the second TRP, or both, based on the first TAT expiring.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for TAG management for multiple TRPs as described herein, or the processor 940 and the memory 930 may be otherwise configured to perform or support such operations.

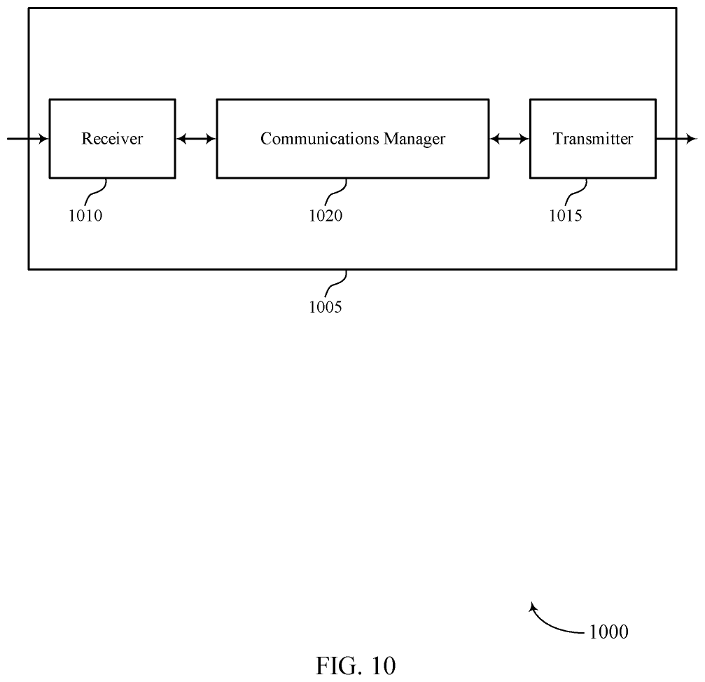

FIG. 10 illustrates a block diagram 1000 of a device 1005 that supports techniques for uplink TAT management for multiple TRPs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for TAG management for multiple TRPs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The communications manager 1020 may be configured as or otherwise support a means for releasing a first one or more network parameters at a TRP-level or a second one or more network parameters at a cell-level, or both, based on the first TAT expiring. The communications manager 1020 may be configured as or otherwise support a means for communicating with a UE via the first TRP or the second TRP, or both, based on the first TAT expiring.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

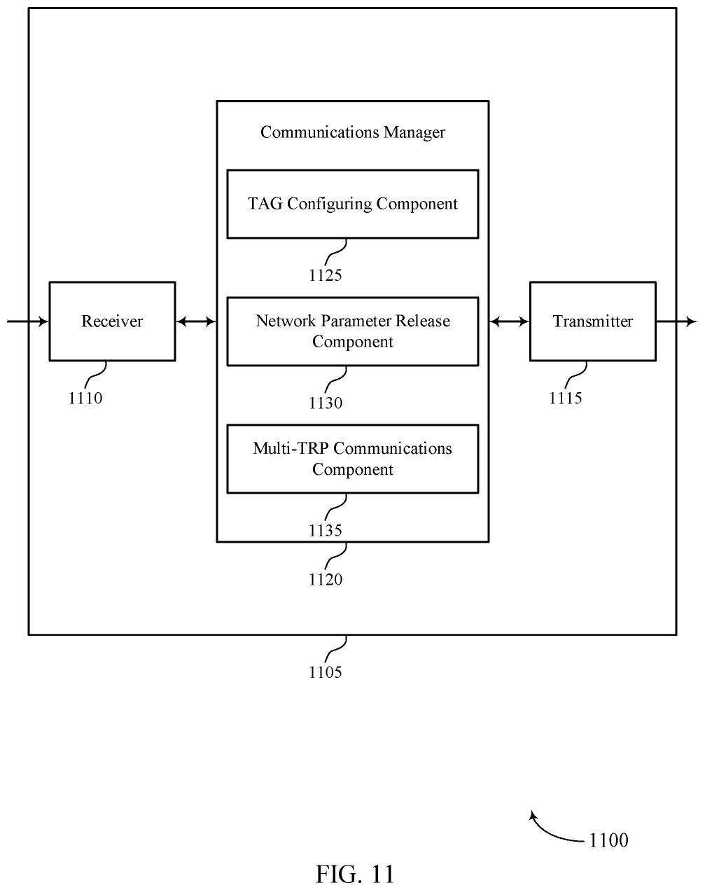

FIG. 11 illustrates a block diagram 1100 of a device 1105 that supports techniques for uplink TAT management for multiple TRPs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for TAG management for multiple TRPs as described herein. For example, the communications manager 1120 may include a TAG configuring component 1125, a network parameter release component 1130, a multi-TRP communications component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The TAG configuring component 1125 may be configured as or otherwise support a means for transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The network parameter release component 1130 may be configured as or otherwise support a means for releasing a first one or more network parameters at a TRP-level or a second one or more network parameters at a cell-level, or both, based on the first TAT expiring. The multi-TRP communications component 1135 may be configured as or otherwise support a means for communicating with a UE via the first TRP or the second TRP, or both, based on the first TAT expiring.

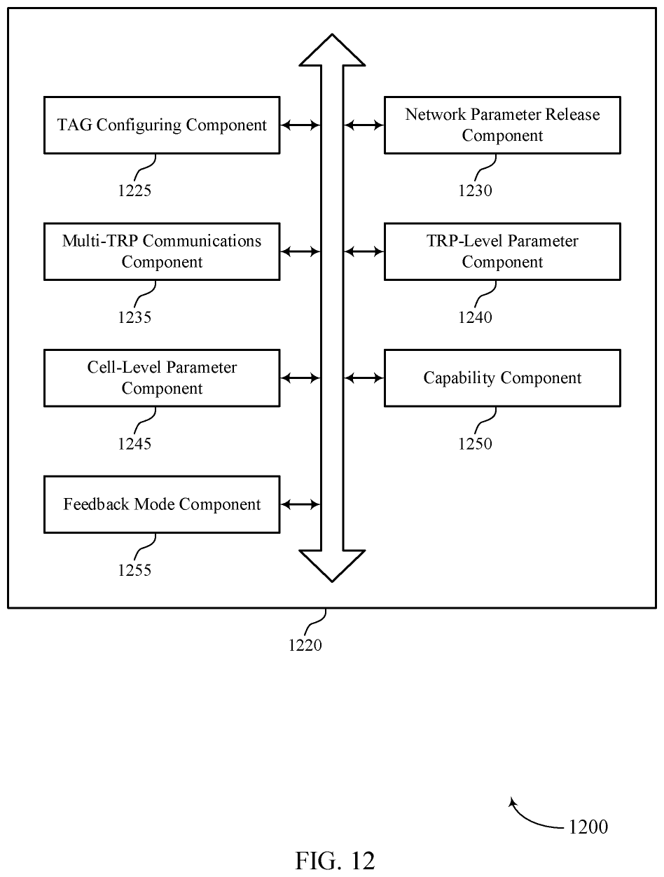

FIG. 12 illustrates a block diagram 1200 of a communications manager 1220 that supports techniques for uplink TAT management for multiple TRPs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for TAG management for multiple TRPs as described herein. For example, the communications manager 1220 may include a TAG configuring component 1225, a network parameter release component 1230, a multi-TRP communications component 1235, an TRP-level parameter component 1240, a cell-level parameter component 1245, a capability component 1250, a feedback mode component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The TAG configuring component 1225 may be configured as or otherwise support a means for transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The network parameter release component 1230 may be configured as or otherwise support a means for releasing a first one or more network parameters at a TRP-level or a second one or more network parameters at a cell-level, or both, based on the first TAT expiring. The multi-TRP communications component 1235 may be configured as or otherwise support a means for communicating with a UE via the first TRP or the second TRP, or both, based on the first TAT expiring.

In some examples, to support releasing, the TRP-level parameter component 1240 may be configured as or otherwise support a means for releasing the first one or more network parameters at the TRP-level for the first TRP based on the first TAG being a first primary TAG and the second TAG being a second primary TAG.

In some examples, the first one or more network parameters are released for all serving cells in a cell group associated with the first TRP.

In some examples, to support communicating, the multi-TRP communications component 1235 may be configured as or otherwise support a means for communicating with the UE via the second TRP based on the second one or more network parameters associated with the second TRP.

In some examples, to support releasing, the cell-level parameter component 1245 may be configured as or otherwise support a means for releasing the second one or more network parameters at the cell-level for each TRP across all serving cells of a same cell group based on the first TAG being a first primary TAG and the second TAG being a second primary TAG.

In some examples, to support releasing, the cell-level parameter component 1245 may be configured as or otherwise support a means for flushing all HARQ buffers based on the first TAT associated with the first primary TAG expiring.

In some examples, to support releasing, the cell-level parameter component 1245 may be configured as or otherwise support a means for flushing all HARQ buffers based on the first TAT expiring and the second TAT expiring.

In some examples, to support releasing, the cell-level parameter component 1245 may be configured as or otherwise support a means for releasing the second one or more network parameters at the cell-level for each TRP across all serving cells of a same cell group based on the first TAG being a primary TAG.

In some examples, to support releasing, the cell-level parameter component 1245 may be configured as or otherwise support a means for releasing the second one or more network parameters at the cell-level for each TRP across serving cells associated with the first TAG based on the first TAG being a secondary TAG.

In some examples, to support releasing, the cell-level parameter component 1245 may be configured as or otherwise support a means for releasing the second one or more network parameters at the cell-level for each TRP across all serving cells of a same cell group based on the first TAT and the second TAT both expiring, where the first TAG is a primary TAG, and the second TAG is a secondary TAG.

In some examples, to support releasing, the cell-level parameter component 1245 may be configured as or otherwise support a means for releasing the second one or more network parameters at the cell-level for each TRP across serving cells associated with the first TAG based on the first TAT and the second TAT both expiring, where the first TAG is a primary TAG, and the second TAG is a secondary TAG.

In some examples, to support releasing, the cell-level parameter component 1245 may be configured as or otherwise support a means for releasing the second one or more network parameters at the cell-level for each TRP across serving cells associated with the first TAG based on the first TAT and the second TAT both expiring, where both the first TAG and the second TAG are secondary TAGs.

In some examples, to support releasing, the capability component 1250 may be configured as or otherwise support a means for releasing the second one or more network parameters at the cell-level or at the TRP-level based on a UE capability to support retransmission across different TRPs.

In some examples, to support releasing, the feedback mode component 1255 may be configured as or otherwise support a means for releasing the second one or more network parameters at the cell-level or the TRP-level based on the control message indicating an acknowledgment feedback mode for a cell group including the serving cell.

In some examples, to support releasing, the feedback mode component 1255 may be configured as or otherwise support a means for releasing the second one or more network parameters at the TRP-level based on the control message indicating a joint acknowledgment feedback mode for a cell group including the serving cell.

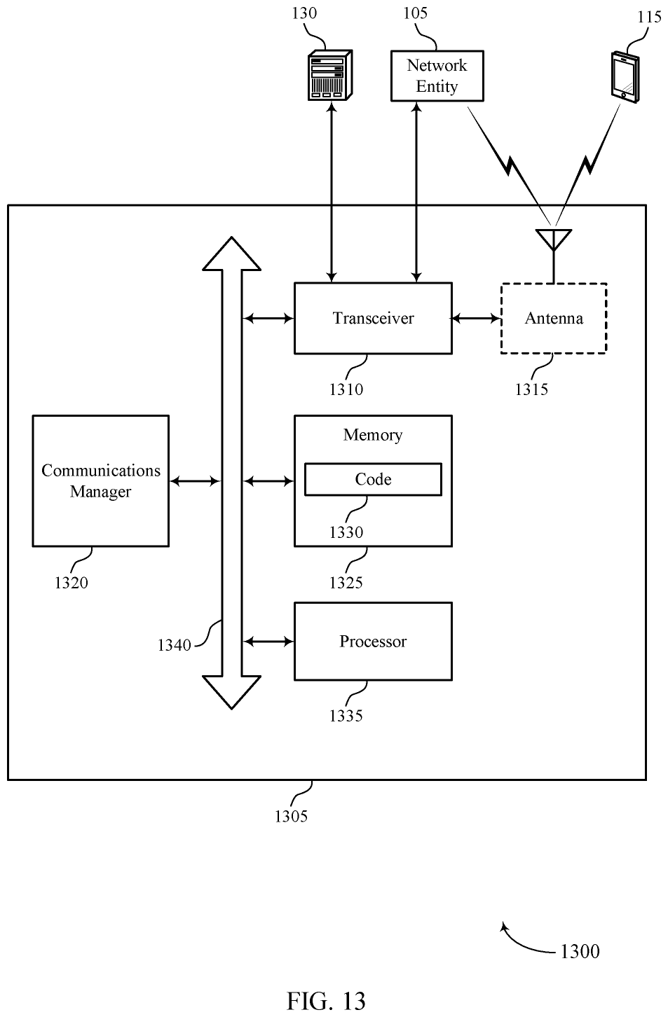

FIG. 13 illustrates a diagram of a system 1300 including a device 1305 that supports techniques for uplink TAT management for multiple TRPs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for TAG management for multiple TRPs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The communications manager 1320 may be configured as or otherwise support a means for releasing a first one or more network parameters at a TRP-level or a second one or more network parameters at a cell-level, or both, based on the first TAT expiring. The communications manager 1320 may be configured as or otherwise support a means for communicating with a UE via the first TRP or the second TRP, or both, based on the first TAT expiring.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for TAG management for multiple TRPs as described herein, or the processor 1335 and the memory 1325 may be otherwise configured to perform or support such operations.

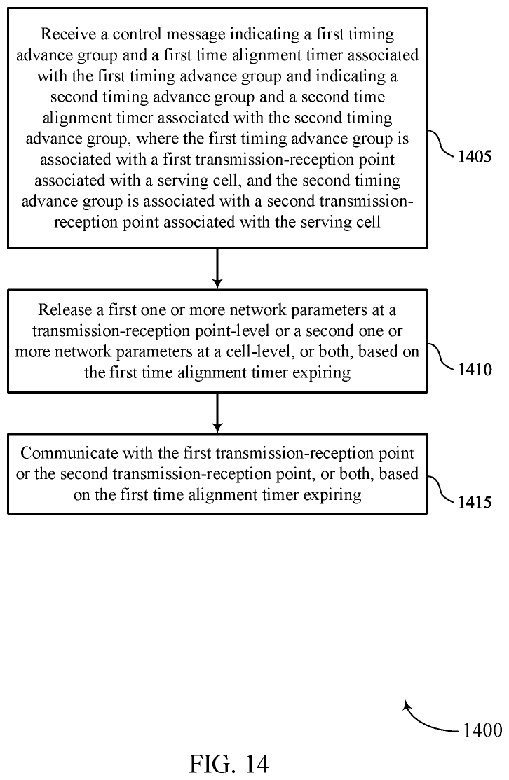

FIG. 14 illustrates a flowchart illustrating a method 1400 that supports techniques for uplink TAT management for multiple TRPs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The operations of 1405 may be performed in accordance with examples as disclosed herein. In some examples, aspects of the operations of 1405 may be performed by a TAG configuration component 825 as described with reference to FIG. 8.

At 1410, the method may include releasing a first one or more network parameters at a TRP-level or a second one or more network parameters at a cell-level, or both, based on the first TAT expiring. The operations of 1410 may be performed in accordance with examples as disclosed herein. In some examples, aspects of the operations of 1410 may be performed by a network parameter release component 830 as described with reference to FIG. 8.

At 1415, the method may include communicating with the first TRP or the second TRP, or both, based on the first TAT expiring. The operations of 1415 may be performed in accordance with examples as disclosed herein. In some examples, aspects of the operations of 1415 may be performed by a multi-TRP communication component 835 as described with reference to FIG. 8.

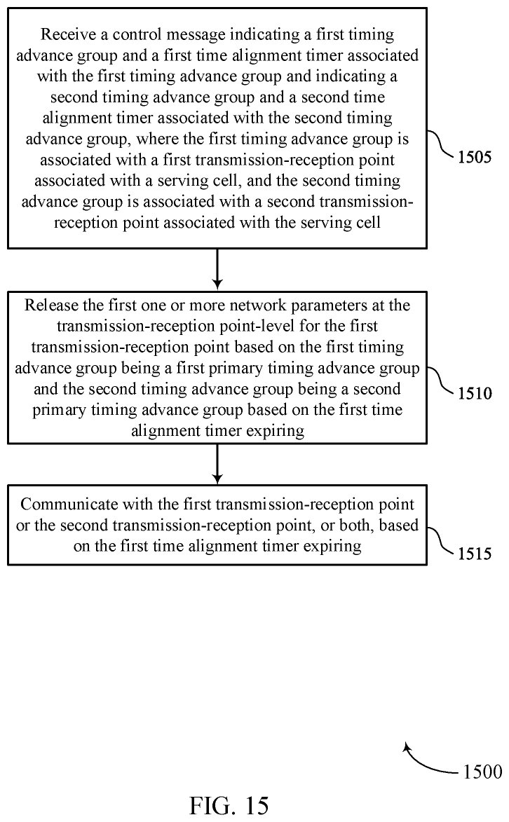

FIG. 15 illustrates a flowchart illustrating a method 1500 that supports techniques for uplink TAT management for multiple TRPs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The operations of 1505 may be performed in accordance with examples as disclosed herein. In some examples, aspects of the operations of 1505 may be performed by a TAG configuration component 825 as described with reference to FIG. 8.

At 1510, the method may include releasing the first one or more network parameters at the TRP-level for the first TRP based on the first TAG being a first primary TAG and the second TAG being a second primary TAG based on the first TAT expiring. The operations of 1510 may be performed in accordance with examples as disclosed herein. In some examples, aspects of the operations of 1510 may be performed by a network parameter release component 830 as described with reference to FIG. 8.

At 1515, the method may include communicating with the first TRP or the second TRP, or both, based on the first TAT expiring. The operations of 1515 may be performed in accordance with examples as disclosed herein. In some examples, aspects of the operations of 1515 may be performed by a multi-TRP communication component 835 as described with reference to FIG. 8.

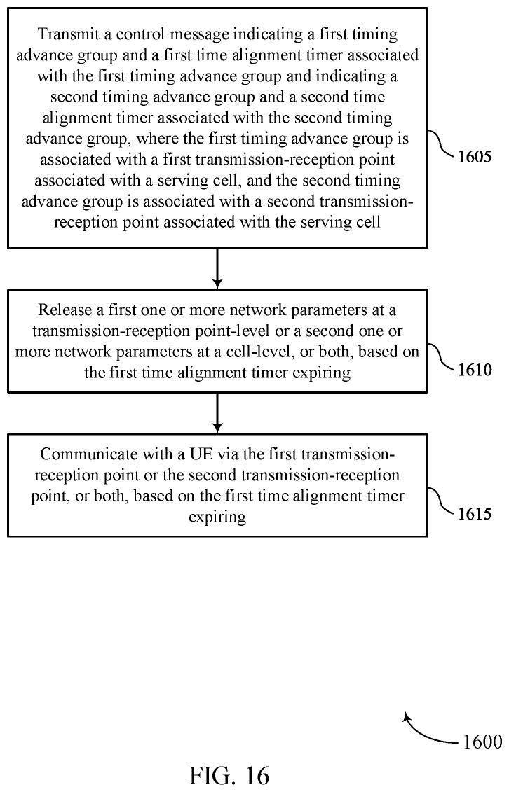

FIG. 16 illustrates a flowchart illustrating a method 1600 that supports techniques for uplink TAT management for multiple TRPs in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The operations of 1605 may be performed in accordance with examples as disclosed herein. In some examples, aspects of the operations of 1605 may be performed by a TAG configuring component 1225 as described with reference to FIG. 12.

At 1610, the method may include releasing a first one or more network parameters at a TRP-level or a second one or more network parameters at a cell-level, or both, based on the first TAT expiring. The operations of 1610 may be performed in accordance with examples as disclosed herein. In some examples, aspects of the operations of 1610 may be performed by a network parameter release component 1230 as described with reference to FIG. 12.

At 1615, the method may include communicating with a UE via the first TRP or the second TRP, or both, based on the first TAT expiring. The operations of 1615 may be performed in accordance with examples as disclosed herein. In some examples, aspects of the operations of 1615 may be performed by a multi-TRP communications component 1235 as described with reference to FIG. 12.

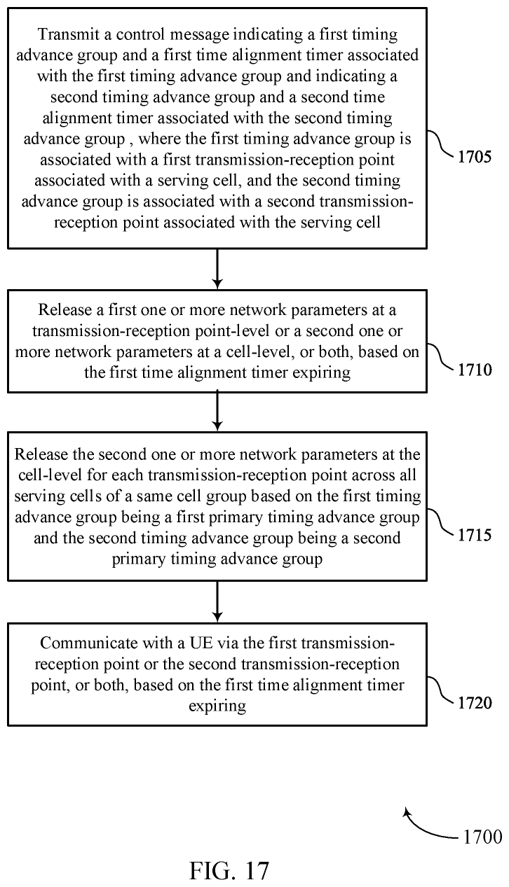

FIG. 17 illustrates a flowchart illustrating a method 1700 that supports techniques for uplink TAT management for multiple TRPs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message indicating a first TAG and a first TAT associated with the first TAG and indicating a second TAG and a second TAT associated with the second TAG, where the first TAG is associated with a first TRP associated with a serving cell, and the second TAG is associated with a second TRP associated with the serving cell. The operations of 1705 may be performed in accordance with examples as disclosed herein. In some examples, aspects of the operations of 1705 may be performed by a TAG configuring component 1225 as described with reference to FIG. 12.

At 1710, the method may include releasing a first one or more network parameters at a TRP-level or a second one or more network parameters at a cell-level, or both, based on the first TAT expiring. The operations of 1710 may be performed in accordance with examples as disclosed herein. In some examples, aspects of the operations of 1710 may be performed by a network parameter release component 1230 as described with reference to FIG. 12.

At 1715, the method may include releasing the second one or more network parameters at the cell-level for each TRP across all serving cells of a same cell group based on the first TAG being a first primary TAG and the second TAG being a second primary TAG. The operations of 1715 may be performed in accordance with examples as disclosed herein. In some examples, aspects of the operations of 1715 may be performed by a cell-level parameter component 1245 as described with reference to FIG. 12.

At 1720, the method may include communicating with a UE via the first TRP or the second TRP, or both, based on the first TAT expiring. The operations of 1720 may be performed in accordance with examples as disclosed herein. In some examples, aspects of the operations of 1720 may be performed by a multi-TRP communications component 1235 as described with reference to FIG. 12.

The following provides an overview of aspects of the present disclosure:

Aspect 1: A method for wireless communications at a UE, comprising: receiving a control message indicating a first timing advance group and a first time alignment timer associated with the first timing advance group and indicating a second timing advance group and a second time alignment timer associated with the second timing advance group, wherein the first timing advance group is associated with a first transmission-reception point associated with a serving cell, and the second timing advance group is associated with a second transmission-reception point associated with the serving cell; releasing a first one or more network parameters at a transmission-reception point-level or a second one or more network parameters at a cell-level, or both, based at least in part on the first time alignment timer expiring; and communicating with the first transmission-reception point or the second transmission-reception point, or both, based at least in part on the first time alignment timer expiring.

Aspect 2: The method of aspect 1, wherein the releasing comprises: releasing the first one or more network parameters at the transmission-reception point-level for the first transmission-reception point based at least in part on the first timing advance group being a first primary timing advance group and the second timing advance group being a second primary timing advance group.

Aspect 3: The method of aspect 2, wherein the first one or more network parameters are released for all serving cells in a cell group associated with the first transmission-reception point.

Aspect 4: The method of any of aspects 2 through 3, wherein the communicating comprises: communicating with the second transmission-reception point via the second one or more network parameters associated with the second transmission-reception point.

Aspect 5: The method of any of aspects 1 through 4, wherein the releasing comprises: releasing the second one or more network parameters at the cell-level for each transmission-reception point across all serving cells of a same cell group based at least in part on the first timing advance group being a first primary timing advance group and the second timing advance group being a second primary timing advance group.

Aspect 6: The method of aspect 5, wherein the releasing comprises: flushing all hybrid automatic repeat request buffers based at least in part on the first time alignment timer associated with the first primary timing advance group expiring.

Aspect 7: The method of any of aspects 5 through 6, wherein the releasing comprises: flushing all hybrid automatic repeat request buffers based at least in part on the first time alignment timer expiring and the second time alignment timer expiring.

Aspect 8: The method of any of aspects 1 through 7, wherein the releasing comprises: releasing the second one or more network parameters at the cell-level for each transmission-reception point across all serving cells of a same cell group based at least in part on the first timing advance group being a primary timing advance group.

Aspect 9: The method of any of aspects 1 through 8, wherein the releasing comprises: releasing the second one or more network parameters at the cell-level for each transmission-reception point across serving cells associated with the first timing advance group based at least in part on the first timing advance group being a secondary timing advance group.

Aspect 10: The method of any of aspects 1 through 9, wherein the releasing comprises: releasing the second one or more network parameters at the cell-level for each transmission-reception point across all serving cells of a same cell group based at least in part on the first time alignment timer and the second time alignment timer both expiring, wherein the first timing advance group is a primary timing advance group, and the second timing advance group is a secondary timing advance group.

Aspect 11: The method of any of aspects 1 through 10, wherein the releasing comprises: releasing the second one or more network parameters at the cell-level for each transmission-reception point across serving cells associated with the first timing advance group based at least in part on the first time alignment timer and the second time alignment timer both expiring, wherein the first timing advance group is a primary timing advance group, and the second timing advance group is a secondary timing advance group.

Aspect 12: The method of any of aspects 1 through 11, wherein the releasing comprises: releasing the second one or more network parameters at the cell-level for each transmission-reception point across serving cells associated with the first timing advance group based at least in part on the first time alignment timer and the second time alignment timer both expiring, wherein both the first timing advance group and the second timing advance group are secondary timing advance groups.

Aspect 13: The method of any of aspects 1 through 12, further comprising: releasing the second one or more network parameters at the cell-level or at the transmission-reception point-level based at least in part on a UE capability to support retransmission across different transmission-reception points.

Aspect 14: The method of aspect 13, further comprising: releasing the second one or more network parameters at the transmission-reception point-level based on supporting retransmission across different transmission-reception points.

Aspect 15: The method of any of aspects 13 through 14, further comprising: releasing the second one or more network parameters at the cell-level based on supporting retransmission across different transmission-reception points.

Aspect 16: The method of any of aspects 13 through 15, further comprising: releasing the second one or more network parameters at the cell-level based on not supporting retransmission across different transmission-reception point the and the first time alignment timer and the second time alignment timer both expiring.

Aspect 17: The method of any of aspects 1 through 16, wherein the releasing comprises: releasing the second one or more network parameters at the cell-level or at the transmission-reception point-level based at least in part on the control message indicating an acknowledgment feedback mode for a cell group including the serving cell.

Aspect 18: The method of aspect 17, wherein the releasing comprises: releasing the second one or more network parameters at the transmission-reception point-level based at least in part on the control message indicating a joint acknowledgment feedback mode for a cell group including the serving cell.

Aspect 19: The method of any of aspects 17 through 18, wherein the releasing comprises: releasing the second one or more network parameters at the cell-level based at least in part on the control message indicating a joint acknowledgment feedback mode for the cell group that the serving cell belong to.

Aspect 20: The method of any of aspects 1 through 19, wherein releasing the first one or more network parameters comprises: flushing all downlink hybrid automatic repeat request buffers, flushing all uplink hybrid automatic repeat request buffers, releasing uplink control channel resources, releasing sounding reference signal resources, releasing configured downlink assignments, releasing configured uplink grants, releasing uplink shared channel resources for semi-persistent channel state information reporting, or any combination thereof.

Aspect 21: The method of any of aspects 1 through 20, wherein releasing the second one or more network parameters comprises: flushing all downlink hybrid automatic repeat request buffers, flushing all uplink hybrid automatic repeat request buffers, or any combination thereof.

Aspect 22: The method of any of aspects 1 through 21, wherein the first transmission-reception point is corresponding to a first control resource set pool index value or a first set of unified transmission configuration indicator states or spatial relations, and the second transmission-reception point is corresponding to a second control resource set pool index value or a second set of unified transmission configuration indicator states or spatial relations.

Aspect 23: A method for wireless communications at a network entity, comprising: transmitting a control message indicating a first timing advance group and a first time alignment timer associated with the first timing advance group and indicating a second timing advance group and a second time alignment timer associated with the second timing advance group, wherein the first timing advance group is associated with a first transmission-reception point associated with a serving cell, and the second timing advance group is associated with a second transmission-reception point associated with the serving cell; releasing a first one or more network parameters at a transmission-reception point-level or a second one or more network parameters at a cell-level, or both, based at least in part on the first time alignment timer expiring; and communicating with a UE via the first transmission-reception point or the second transmission-reception point, or both, based at least in part on the first time alignment timer expiring.

Aspect 24: The method of aspect 23, wherein the releasing comprises: releasing the first one or more network parameters at the transmission-reception point-level for the first transmission-reception point based at least in part on the first timing advance group being a first primary timing advance group and the second timing advance group being a second primary timing advance group.

Aspect 25: The method of aspect 24, wherein the first one or more network parameters are released for all serving cells in a cell group associated with the first transmission-reception point.

Aspect 26: The method of any of aspects 24 through 25, wherein the communicating comprises: communicating with the UE via the second transmission-reception point based at least in part on the second one or more network parameters associated with the second transmission-reception point.

Aspect 27: The method of any of aspects 23 through 26, wherein the releasing comprises: releasing the second one or more network parameters at the cell-level for each transmission-reception point across all serving cells of a same cell group based at least in part on the first timing advance group being a first primary timing advance group and the second timing advance group being a second primary timing advance group.

Aspect 28: The method of aspect 27, wherein the releasing comprises: flushing all hybrid automatic repeat request buffers based at least in part on the first time alignment timer associated with the first primary timing advance group expiring.

Aspect 29: The method of any of aspects 27 through 28, wherein the releasing comprises: flushing all hybrid automatic repeat request buffers based at least in part on the first time alignment timer expiring and the second time alignment timer expiring.

Aspect 30: The method of any of aspects 23 through 29, wherein the releasing comprises: releasing the second one or more network parameters at the cell-level for each transmission-reception point across all serving cells of a same cell group based at least in part on the first timing advance group being a primary timing advance group.

Aspect 31: The method of any of aspects 23 through 30, wherein the releasing comprises: releasing the second one or more network parameters at the cell-level for each transmission-reception point across serving cells associated with the first timing advance group based at least in part on the first timing advance group being a secondary timing advance group.

Aspect 32: The method of any of aspects 23 through 31, wherein the releasing comprises: releasing the second one or more network parameters at the cell-level for each transmission-reception point across all serving cells of a same cell group based at least in part on the first time alignment timer and the second time alignment timer both expiring, wherein the first timing advance group is a primary timing advance group, and the second timing advance group is a secondary timing advance group.

Aspect 33: The method of any of aspects 23 through 32, wherein the releasing comprises: releasing the second one or more network parameters at the cell-level for each transmission-reception point across serving cells associated with the first timing advance group based at least in part on the first time alignment timer and the second time alignment timer both expiring, wherein the first timing advance group is a primary timing advance group, and the second timing advance group is a secondary timing advance group.

Aspect 34: The method of any of aspects 23 through 33, wherein the releasing comprises: releasing the second one or more network parameters at the cell-level for each transmission-reception point across serving cells associated with the first timing advance group based at least in part on the first time alignment timer and the second time alignment timer both expiring, wherein both the first timing advance group and the second timing advance group are secondary timing advance groups.

Aspect 35: The method of any of aspects 23 through 34, wherein the releasing comprises: releasing the second one or more network parameters at the cell-level or at the transmission-reception point-level based at least in part on a UE capability to support retransmission across different transmission-reception points.

Aspect 36: The method of any of aspects 23 through 35, wherein the releasing comprises: releasing the second one or more network parameters at the cell-level or the transmission-reception point-level based at least in part on the control message indicating an acknowledgment feedback mode for a cell group including the serving cell.

Aspect 37: The method of any of aspects 23 through 36, wherein the releasing comprises: releasing the second one or more network parameters at the transmission-reception point-level based at least in part on the control message indicating a joint acknowledgment feedback mode for a cell group including the serving cell.

Aspect 38: An apparatus for wireless communications at a UE, comprising memory; a transceiver; and at least one processor of the UE, the at least one processor coupled with the memory and the transceiver and configured to perform a method of any of aspects 1 through 22.

Aspect 39: An apparatus for wireless communications at a UE, comprising at least one means for performing a method of any of aspects 1 through 22.

Aspect 40: A non-transitory computer-readable medium storing code for wireless communications at a UE, the code comprising instructions executable by a processor to perform a method of any of aspects 1 through 22.

Aspect 41: An apparatus for wireless communications at a network entity, comprising a processor; memory coupled with the processor; and instructions stored in the memory and executable by the processor to cause the apparatus to perform a method of any of aspects 23 through 37.

Aspect 42: An apparatus for wireless communications at a network entity, comprising at least one means for performing a method of any of aspects 23 through 37.

Aspect 43: A non-transitory computer-readable medium storing code for wireless communications at a network entity, the code comprising instructions executable by a processor to perform a method of any of aspects 23 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
memory;
a transceiver; and
at least one processor of the UE, the at least one processor coupled with the memory and the transceiver and configured to:
receive, via the transceiver, a control message indicating a first timing advance group and a first time alignment timer associated with the first timing advance group and indicating a second timing advance group and a second time alignment timer associated with the second timing advance group, wherein the first timing advance group is associated with a first transmission-reception point associated with a serving cell, and the second timing advance group is associated with a second transmission-reception point associated with the serving cell;
release a first one or more network parameters at a transmission-reception point-level or a second one or more network parameters at a cell-level, or both, based at least in part on the first time alignment timer expiring; and
communicate, via the transceiver, with the first transmission-reception point or the second transmission-reception point, or both, based at least in part on the first time alignment timer expiring.

2. The apparatus of claim 1, wherein, to release, the at least one processor is further configured to:
release the first one or more network parameters at the transmission-reception point-level for the first transmission-reception point based at least in part on the first timing advance group being a first primary timing advance group and the second timing advance group being a second primary timing advance group.

3. The apparatus of claim 2, wherein the first one or more network parameters are released for all serving cells in a cell group associated with the first transmission-reception point.

4. The apparatus of claim 2, wherein, to communicate, the at least one processor is further configured to:
communicate with the second transmission-reception point via the second one or more network parameters associated with the second transmission-reception point.

5. The apparatus of claim 1, wherein, to release, the at least one processor is further configured to:
release the second one or more network parameters at the cell-level for each transmission-reception point across all serving cells of a same cell group based at least in part on the first timing advance group being a first primary timing advance group and the second timing advance group being a second primary timing advance group.

6. The apparatus of claim 5, wherein, to release, the at least one processor is further configured to:
flush all hybrid automatic repeat request buffers based at least in part on the first time alignment timer associated with the first primary timing advance group expiring, or
flush all hybrid automatic repeat request buffers based at least in part on the first time alignment timer expiring and the second time alignment timer expiring.

7. (canceled)

8. The apparatus of claim 1, wherein, to release, the at least one processor is further configured to:
release the second one or more network parameters at the cell-level for each transmission-reception point across all serving cells of a same cell group based at least in part on the first timing advance group being a primary timing advance group.

9. The apparatus of claim 1, wherein, to release, the at least one processor is further configured to:
release the second one or more network parameters at the cell-level for each transmission-reception point across serving cells associated with the first timing advance group based at least in part on the first timing advance group being a secondary timing advance group.

10. The apparatus of claim 1, wherein, to release, the at least one processor is further configured to:
release the second one or more network parameters at the cell-level for each transmission-reception point across all serving cells of a same cell group based at least in part on the first time alignment timer and the second time alignment timer both expiring, wherein the first timing advance group is a primary timing advance group, and the second timing advance group is a secondary timing advance group.

11. The apparatus of claim 1, wherein, to release, the at least one processor is further configured to:
release the second one or more network parameters at the cell-level for each transmission-reception point across serving cells associated with the first timing advance group based at least in part on the first time alignment timer and the second time alignment timer both expiring, wherein the first timing advance group is a primary timing advance group, and the second timing advance group is a secondary timing advance group.

12. The apparatus of claim 1, wherein, to release, the at least one processor is further configured to:
release the second one or more network parameters at the cell-level for each transmission-reception point across serving cells associated with the first timing advance group based at least in part on the first time alignment timer and the second time alignment timer both expiring, wherein both the first timing advance group and the second timing advance group are secondary timing advance groups.

13. The apparatus of claim 1, the at least one processor further configured to:
release the second one or more network parameters at the cell-level or at the transmission-reception point-level based at least in part on a UE capability to support retransmission across different transmission-reception points.

14. The apparatus of claim 13, the at least one processor further configured to:
release the second one or more network parameters at the transmission-reception point-level based on supporting retransmission across different transmission-reception points,
release the second one or more network parameters at the cell-level based on supporting retransmission across different transmission-reception points, or
release the second one or more network parameters at the cell-level based on not supporting retransmission across different transmission-reception points and the first time alignment timer and the second time alignment timer both expiring.

15. (canceled)

16. (canceled)

17. The apparatus of claim 1, wherein, to release, the at least one processor is further configured to:
release the second one or more network parameters at the cell-level or at the transmission-reception point-level based at least in part on the control message indicating an acknowledgment feedback mode for a cell group including the serving cell.

18. (canceled)

19. (canceled)

20. The apparatus of claim 1, wherein, to release the first one or more network parameters, the at least one processor is further configured to:
flush all downlink hybrid automatic repeat request buffers, flush all uplink hybrid automatic repeat request buffers, release uplink control channel resources, releasing sounding reference signal resources, release configured downlink assignments, release configured uplink grants, release uplink shared channel resources for semi-persistent channel state information reporting, or any combination thereof.

21. (canceled)

22. The apparatus of claim 1, wherein the first transmission-reception point is corresponding to a first control resource set pool index value or a first set of unified transmission configuration indicator states or spatial relations, and the second transmission-reception point is corresponding to a second control resource set pool index value or a second set of unified transmission configuration indicator states or spatial relations.

23. An apparatus for wireless communications at a network entity, comprising:
a processor;
memory coupled with the processor; and
instructions stored in the memory and executable by the processor to cause the apparatus to:
transmit a control message indicating a first timing advance group and a first time alignment timer associated with the first timing advance group and indicating a second timing advance group and a second time alignment timer associated with the second timing advance group, wherein the first timing advance group is associated with a first transmission-reception point associated with a serving cell, and the second timing advance group is associated with a second transmission-reception point associated with the serving cell;
release a first one or more network parameters at a transmission-reception point-level or a second one or more network parameters at a cell-level, or both, based at least in part on the first time alignment timer expiring; and
communicate with a user equipment (UE) via the first transmission-reception point or the second transmission-reception point, or both, based at least in part on the first time alignment timer expiring.

24. The apparatus of claim 23, wherein, to release, the processor is further configured to cause the apparatus to:
release the first one or more network parameters at the transmission-reception point-level for the first transmission-reception point based at least in part on the first timing advance group being a first primary timing advance group and the second timing advance group being a second primary timing advance group, or
release the second one or more network parameters at the cell-level for each transmission-reception point across all serving cells of a same cell group based at least in part on the first timing advance group being a first primary timing advance group and the second timing advance group being a second primary timing advance group.

25. (canceled)

26. The apparatus of claim 23, wherein, to release, the processor is further configured to cause the apparatus to:
release the second one or more network parameters at the cell-level for each transmission-reception point across all serving cells of a same cell group based at least in part on the first timing advance group being a primary timing advance group,
release the second one or more network parameters at the cell-level for each transmission-reception point across serving cells associated with the first timing advance group based at least in part on the first timing advance group being a secondary timing advance group, or
release the second one or more network parameters at the cell-level for each transmission-reception point across all serving cells of a same cell group based at least in part on the first time alignment timer and the second time alignment timer both expiring, wherein the first timing advance group is a primary timing advance group, and the second timing advance group is a secondary timing advance group.

27. (canceled)

28. (canceled)

29. A method for wireless communications at a user equipment (UE), comprising:
receiving a control message indicating a first timing advance group and a first time alignment timer associated with the first timing advance group and indicating a second timing advance group and a second time alignment timer associated with the second timing advance group, wherein the first timing advance group is associated with a first transmission-reception point associated with a serving cell, and the second timing advance group is associated with a second transmission-reception point associated with the serving cell;
releasing a first one or more network parameters at a transmission-reception point-level or a second one or more network parameters at a cell-level, or both, based at least in part on the first time alignment timer expiring; and
communicating with the first transmission-reception point or the second transmission-reception point, or both, based at least in part on the first time alignment timer expiring.

30. (canceled)
